(19) United States
(12) Patent Application Publication
(10) Pub. No.: US 2010/0160184 A1
(43) Pub. Date: Jun. 24, 2010

(54) CROSS TYPE MAGNETIC ARRAY SENSORS FOR BIOMOLECULES MAGNETIC BEAD DETECTION

(75) Inventors: Jeongdae SUH, Daejeon-city (KR); Sangdon Jung, Daejeon-city (KR); Myungae Chung, Daejeon-city (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATION RESEARCH INSTITUTE, Daejeon-city (KR)

(21) Appl. No.: 12/612,328

(22) Filed: Nov. 4, 2009

(30) Foreign Application Priority Data
Dec. 22, 2008 (KR) 10-2008-0131572

(51) Int. Cl. C40B 60/12

(52) U.S. Cl. 506/39

(57) ABSTRACT

There is provided a cross-type magnetic array sensor for biomolecules magnetic bead detection having a structure of various types, which can be used as a high-sensitivity and high-density magnetic biosensor. Since a vertical output voltage vertically crossing an applied current direction can be measured, it is possible to measure high-sensitivity magnetic-field variation in comparison with a known magnetic bead detection device that measures an output voltage parallel to the applied current direction. As a result, a magnetic bead magnetic-field detection device having a high signal-to-noise ratio can be achieved. Further, since the cross-type magnetic array sensors for biomolecules magnetic bead detection measure a vertical voltage, magnetic beads can be magnetized by an applied current induction magnetic field that is generated by an applied current without a magnetic field applied from the outside.

### RELATED APPLICATIONS

The present application claims priority to Korean Patent Application Serial Number 10-2008-0131572, filed on Dec. 22, 2008, the entirety of which is hereby incorporated by reference.

### BACKGROUND OF THE INVENTION

1. Field of the Invention

The present invention relates to cross-type magnetic array sensors for biomolecules magnetic bead detection, and more particularly, to cross-type magnetic array sensors using a magnetoresistance thin film for detecting a weak magnetic field generated by magnetic beads having a size of dozens of nanometers to several micrometers.

2. Description of the Related Art

A micro-device and an array device using the same have a large influence on analysis of DNA, RNA, protein, virus, bacteria, etc. Magnetic biosensors using spherical magnetic particles (hereinafter, referred to as ‘magnetic bead’) having sizes of tens nms to several ums in order to effectively analyze biomolecules have been researched.

A magnetic biosensor includes a magnetic-field sensing device that is combined with a biochemical layer which can be combined with predetermined molecules. The magnetic biosensor detects and analyzes the biomolecules by using the magnetic beads which are superparamagnetic particles having sizes of nanometers to micrometers, which are combined with biochemical molecules. When an analysis solution including the magnetic beads drops on a magnetic bead detection device, captured biomolecules fixed onto the surface of the magnetic bead detection device and target biomolecules attached onto the surface of the magnetic bead are specifically combined with each other. At this time, when the magnetic beads are magnetized by applying an external magnetic field to the magnetic beads, the magnetic bead detection device indirectly detects the biomolecules by detecting the magnetic field which is generated in the magnetic bead.

The magnetic beads are generally detected by a structure (that is, magnetic bead detection device) using a magnetoresistance device having a rectangular structure as shown in FIGS. 1A and 1B. FIG. 1A is a plan view and FIG. 1B is a cross-sectional view taken along line A-A of FIG. 1A. In FIGS. 1A and 1B, reference numeral 1 represents a single crystalline substrate of Si/SiO₂, reference numeral 2 represents a rectangular magnetoresistance device formed on a substrate 10, and reference numeral 3 represents an applied current electrode connected to a magnetoresistance device 2.

The known magnetic bead detection device using the magnetoresistance device having the rectangular structure includes a rectangular magnetic bead detection device and array structure (M. C. Tondra, U.S. Pat. No. 6,875,621 B2) of which both ends have a sharp triangular structure, a rectangular magnetic-field detection device (G. Li, et al. Journal of Applied Physics 93, 7557 (2003)) of which an end has a semicircular structure, a magnetic bead detection device structure (J. C. Rife, et al. Sensors and Actuators, A107, 209 (2003)) having a structure connecting a rectangular magnetoresistance device, a magnetic bead detection device structure (J. Schotter, et al., Biosensors and Bioelectronics 19, 1149 (2004)) having a spiral magnetoresistance device transformed from the rectangular magnetoresistance device, and a magnetic bead detection device structure (H. A. Ferreira et al. Journal of Applied Physics 99, 08P105 (2006)) having a U-shaped magnetoresistance device transformed from the rectangular magnetoresistance device.

Besides, a magnetoresistance device having a cross-type structure is disclosed. A magnetic-field detection device for a magnetic memory device (C. Ahn, et al., US 2007/0096228 A1) using the cross-type magnetoresistance device and a magnetoresistance device (L. Ejsing, et al., Applied Physics Letters, V84,4279 (2004)) for detecting magnetic beads shown in FIGS. 2A and 2B are disclosed. FIG. 2A is a plan view and FIG. 2B is a cross-sectional view taken along line A-A of FIG. 2A. In FIGS. 2A and 2B, reference numeral 1 represents a single crystalline substrate of Si/SiO₂, reference numeral 5 is a cross-type magnetoresistance device formed on the substrate 10, reference numeral 3 is an applied current electrode connected to the magnetoresistance device 5, and reference numeral 4 is a vertical voltage measurement electrode connected to the magnetoresistance device 5.

The known magnetic bead detection device using the rectangular magnetoresistance device uses a magnetic bead magnetic-field detection device structure that measures an output voltage of a magnetic device in an applied current direction. When the known magnetic bead detection device using the rectangular magnetoresistance device is applied with an external magnetic field, magnetization is generated only in one direction from one end to the other end of the device. The generated magnetization generates a stray field in which the magnetic field is generated outside the device. Therefore, a signal-to-noise ratio is low and a stable operation of the magnetic bead detection device is influenced, such that the magnetic bead detection device is not suitable for being used as a high-density magnetic bead detection device. The magnetization of the magnetoresistance device is influenced by the magnetic field generated by the stray field of the magnetic beads and a resistance of the magnetic detection device is varied more sensitively in a direction vertical to an applied current than in a direction parallel to the applied current by the influence.

### SUMMARY OF THE INVENTION

The present invention is contrived to solve the above-mentioned problems. An object of the present invention is to provide cross-type magnetic array sensors for biomolecules magnetic bead detection, which have various shapes, which can be used as a high-density and high-sensitivity magnetic biosensor.

In order to achieve the above-mentioned object, a cross-type magnetic array sensor for biomolecules magnetic bead detection according to an aspect of the present invention includes: a substrate; a plurality of cross-type magnetoresistance devices that are formed on the top of the substrate and are formed by using a thin film for detecting biomolecules; electrode pads that are formed on the top of the substrate and connected to the plurality of cross-type magnetoresistance devices; a protection layer that is formed on the tops of the plurality of cross-type magnetoresistance device and the electrode pads; a biomolecules fixed layer that is formed on the top of the protection layer to fix the biomolecules; and a magnetic bead container layer that surrounds the biomolecules fixed layer and coops up a magnetic bead analysis solution in the surrounded area.

A cross-type magnetic array sensor for biomolecules magnetic bead detection according to another aspect of the present invention includes: a substrate; a plurality of cross-type magnetoresistance devices that are formed on the top of the substrate and are formed by using a thin film for detecting biomolecules; electrode pads that are formed on the top of the substrate and connected to the plurality of cross-type magnetoresistance devices; a protection layer that is formed on the tops of the plurality of cross-type magnetoresistance device and the electrode pads; a biomolecules fixed layer that is formed on the top of the protection layer to fix the biomolecules; and a magnetic bead analysis moving layer that is formed on the biomolecules fixed layer and moves a magnetic bead analysis solution to the plurality of cross-type magnetoresistance devices.

In the above-mentioned aspects, the substrate is a Si single crystalline substrate of which the surface is oxidized. The thin film is any one of a giant magnetoresistance thin film, a spin valve thin film, and an anisotropic magnetoresistance thin film. The thin film is configured by sequentially forming a seed layer, an anti-ferromagnetic layer, a fixed layer, a space layer, a free layer, and a protection layer. The plurality of cross-type magnetoresistance devices each have a size of 100 nm to 100 μm.

In the above-mentioned aspects, the plurality of cross-type magnetoresistance devices are formed on the substrate in a one-dimensional array pattern in which the magnetoresistance devices are independently arrayed in line. On the other hand, the plurality of cross-type magnetoresistance devices are formed on the substrate in a one-dimensional array pattern in which the magnetoresistance devices are connected to each other to be integrated. On the other hand, the plurality of cross-type magnetoresistance devices are formed on the substrate in a two-dimensional array pattern in which the magnetoresistance devices are independently arrayed in a matrix pattern. On the other hand, the plurality of cross-type magnetoresistance devices are formed on the substrate in a two-dimensional array pattern in which the magnetoresistance devices are connected to each other to be integrated.

In the above-mentioned aspects, the electrode pad is made of Ta or Au. The electrode pad has a thickness of 50 to 300 nm at room temperature. The protection layer is made of SiO₂ or Si₃N₄. The protection layer has a thickness of 50 to 300 nm at room temperature. The biomolecules fixed layer is made of Au. The biomolecules fixed layer has a thickness of 50 to 300 nm at room temperature.

The magnetic bead container layer is formed by using a photosensitive thin film and the magnetic bead container layer has a thickness of 1 to 5 lam at room temperature.

The magnetic bead analysis moving layer is constituted by a moving channel having a predetermined length, of which one end is connected to a magnetic bead solution inlet and the other end is connected to an outlet.

The magnetic bead analysis moving layer is made of any one material of PDMS, PMMA, and an SU-8 polymer.

According to an embodiment of the present invention, since a vertical output voltage vertically crossing an applied current direction can be measured, it is possible to measure high-sensitivity magnetic-field variation in comparison with a known magnetic bead detection device that measures an output voltage parallel to the applied current direction. As a result, a magnetic bead magnetic-field detection device having a high signal-to-noise ratio can be achieved.

Further, since the cross-type magnetic array sensors for biomolecules magnetic bead detection measure a vertical voltage, magnetic beads can be magnetized by an applied current induction magnetic field that is generated by an applied current without a magnetic field applied from the outside. Since this magnetized field sensitively influences the vertical voltage, a convenient magnetic biosensor that does not need the magnetic field applied from the outside can be implemented. Accordingly, a high-density and high-sensitivity magnetic biosensor can be manufactured by using the cross-type magnetic array sensor for biomolecules magnetic bead detection.

### BRIEF DESCRIPTION OF THE DRAWINGS

FIGS. 1A and 1B are diagrams illustrating a magnetic bead detection device using a known rectangular magnetoresistance device;

FIGS. 2A and 2B are diagrams illustrating a magnetic bead detection device using a known cross-type magnetoresistance device;

FIGS. 3A to 3C are diagrams illustrating a lamination structure of a giant magnetoresistance thin film adopted in the present invention;

FIG. 4 is a graph measuring a relationship between an applied magnetic field and a voltage of cross-type magnetic array sensors for biomolecules magnetic bead detection using a giant magnetoresistance thin film according to the present invention;

FIGS. 5A to 14 are diagrams for illustrating a structure and a manufacturing process of a cross-type magnetic array sensor for biomolecules magnetic bead detection according to a first embodiment of the present invention;

FIGS. 15A and 15B are diagrams illustrating a modified example of a first embodiment of the present invention;

FIGS. 16A to 25 are diagrams for illustrating a structure and a manufacturing process of a cross-type magnetic array sensor for biomolecules magnetic bead detection according to a second embodiment of the present invention;

FIGS. 26A and 26B are diagrams illustrating a modified example of a second embodiment of the present invention;

FIGS. 27A to 36 are diagrams for illustrating a structure and a manufacturing process of a cross-type magnetic array sensor for biomolecules magnetic bead detection according to a third embodiment of the present invention;

FIGS. 37A and 37B are diagrams illustrating a modified example of a third embodiment of the present invention;

FIGS. 38A to 47 are diagrams for illustrating a structure and a manufacturing process of a cross-type magnetic array sensor for biomolecules magnetic bead detection according to a fourth embodiment of the present invention; and

FIGS. 48A and 48B are diagrams illustrating a modified example of a fourth embodiment of the present invention.

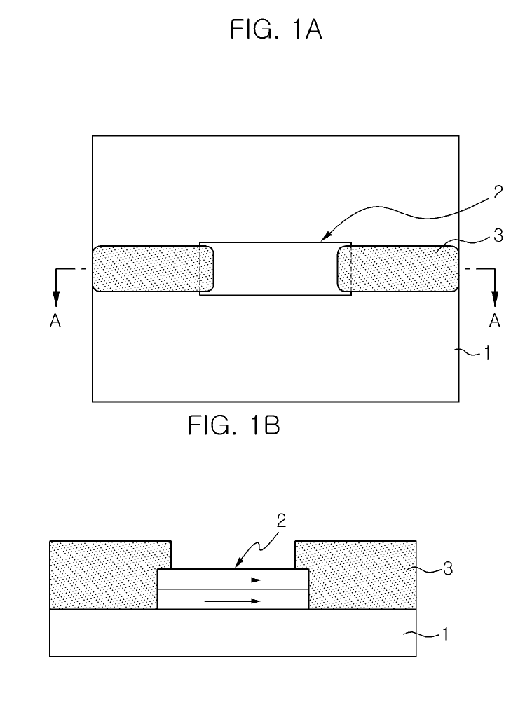

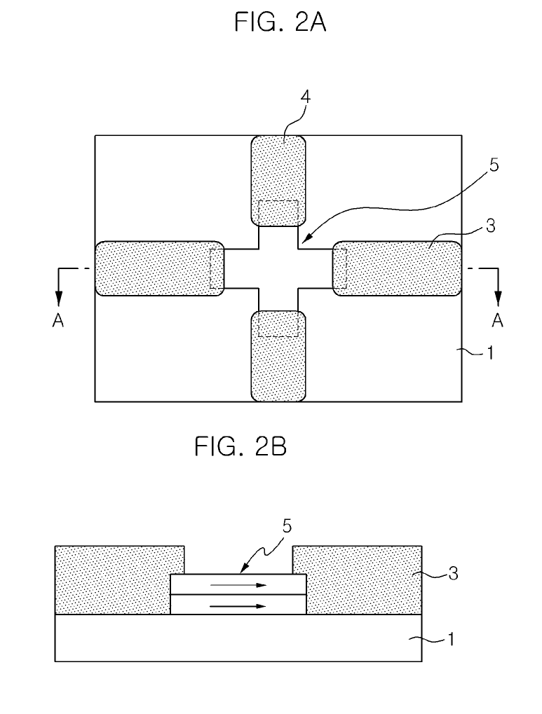

### DETAILED DESCRIPTION OF THE PREFERRED EMBODIMENTS

Hereinafter, a cross-type magnetic array sensor for biomolecules magnetic bead detection according to an embodiment of the present invention will be described with reference to the accompanying drawings.

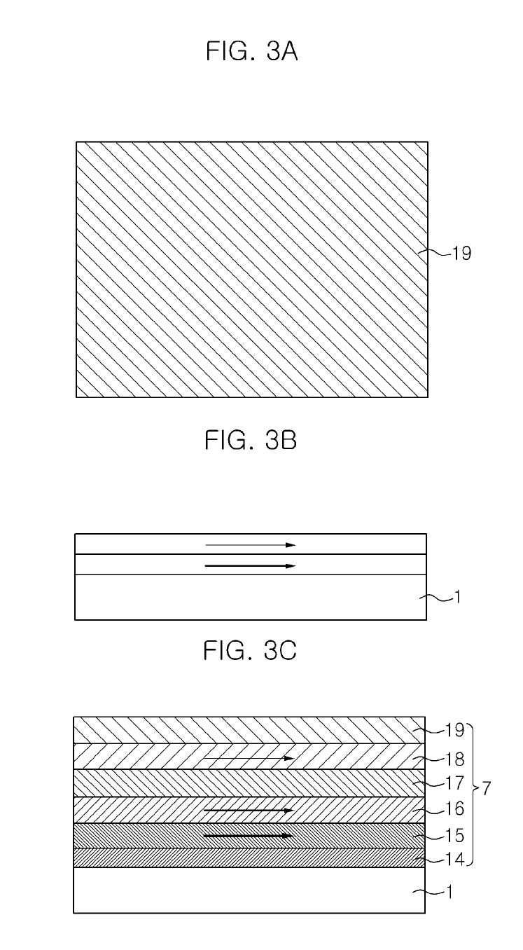

FIGS. 3A to 3C are diagrams illustrating a lamination structure of a giant magnetoresistance thin film adopted in the present invention. In FIG. 3C, a substrate 1 is a single crystalline substrate of Si or SiO₂. An SiO₂ oxide layer is formed on the surface of the substrate 1. A giant magnetoresistance thin film 7 having a lamination structure of a seed layer, a free layer, a space layer, a fixed layer, an anti-ferromagnetic layer, and a protection layer is deposited on the top of the substrate 1. For example, the seed layer 14 is laminated on the top of the substrate 1 and the anti-ferromagnetic layer 15 is laminated on the top of the seed layer 14. The fixed layer 16 is laminated on the top of the anti-ferromagnetic layer 15 and the space layer 17 is laminated on the top of the fixed layer 16. The free layer 18 is laminated on the top of the space layer 17 and the protection layer 19 is laminated on the top of the free layer 18.

The seed layer 14 and the protection layer 19 are made of, for example, a Ta film and each layer has a thickness of approximately 5 nm. The anti-ferromagnetic layer 15 is made of, for example, an IrMn film and the anti-ferromagnetic layer 15 has a thickness of approximately 15 nm. The fixed layer 16 is made of, for example, a Ni₈₈Fe₂₀ film and the fixed layer 16 has a thickness of approximately 3 nm. The space layer 17 is made of, for example, a Cu film and the space layer 17 has a thickness of approximately 3 nm. The free layer 18 is made of, for example, the Ni₈₀Fe₂₀ film and the free layer 18 has a thickness of approximately 6 nm. A magnetization direction of the fixed layer 16 is fixed and the anti-ferromagnetic layer 15 is used to fix the magnetization direction of the fixed layer 16. A magnetization direction of the free layer 18 is not fixed.

The giant magnetoresistance thin film 7 having the lamination structure and thickness grows up by a sequential sputtering deposition method. The above-mentioned fixed layer 16 and the free layer 18 may use a Co₈₀Fe₂₀ film instead of the Ni₈₀Fe₂₀ film. FIG. 3A is a plan view of the protection layer 19 and FIG. 3B is a cross-sectional view illustrating the fixed layer 16 and the free layer 18 of the giant magnetoresistance thin film 7. Unlike the above-mentioned lamination sequence, the lamination sequence of the giant magnetoresistance thin film 7 is the seed layer, the free layer, the space layer, the fixed layer, the anti-ferromagnetic layer, and the protection layer.

The magnetoresistance device illustrated in the figures shown below is manufactured in a desired shape by etching the giant magnetoresistance thin film 7. In the figures shown below, as schematically shown in FIG. 3B, the magnetoresistance device includes the fixed layer 16 and the free layer 18. An arrow illustrated in the fixed layer 16 and the free layer 18 of FIGS. 3A to 3C illustrate a magnetization diagrams. Meanwhile, the magnetoresistance device may be manufactured by using an anisotropic magnetoresistance thin film a spin valve thin film, a tunnel type magnetoresistance thin film, etc. Preferably, in the present invention, the magnetoresistance device can be manufactured by using the spin valve thin film other than the giant magnetoresistance thin film 7.

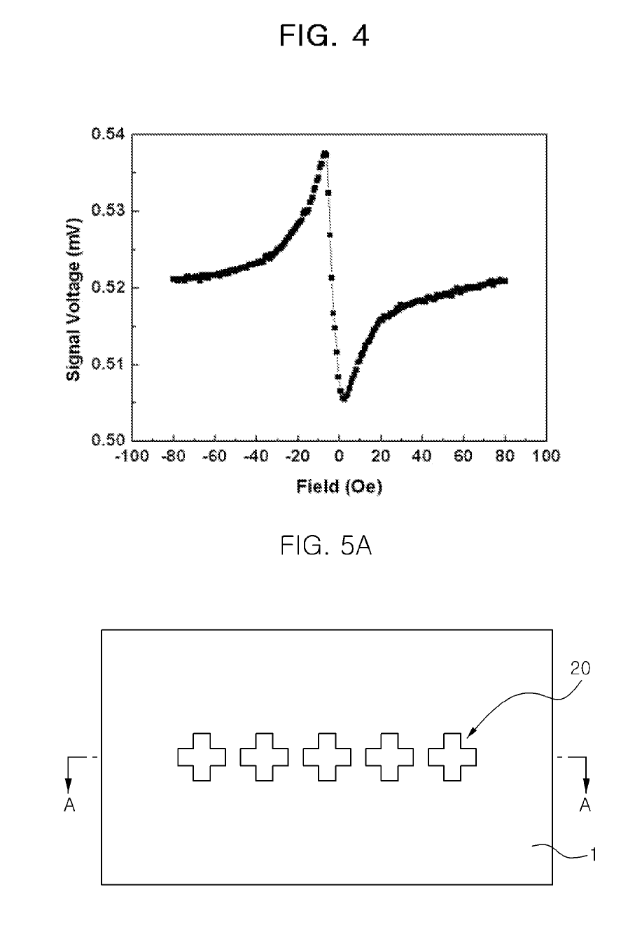

FIG. 4 is a graph measuring a relationship between an applied magnetic field and a voltage of cross-type magnetic array sensors for biomolecules bead detection using a giant magnetoresistance thin film according to the present invention.

A voltage is rapidly varied in a magnetic-field area around 0 (zero) oersted (Oe). From the result, it can be appreciated that the cross-type magnetic array sensor for biomolecules magnetic bead detection manufactured by the above-mentioned manufacturing method can detect a weak magnetic field having a minimal size with high sensitivity.

### First Embodiment

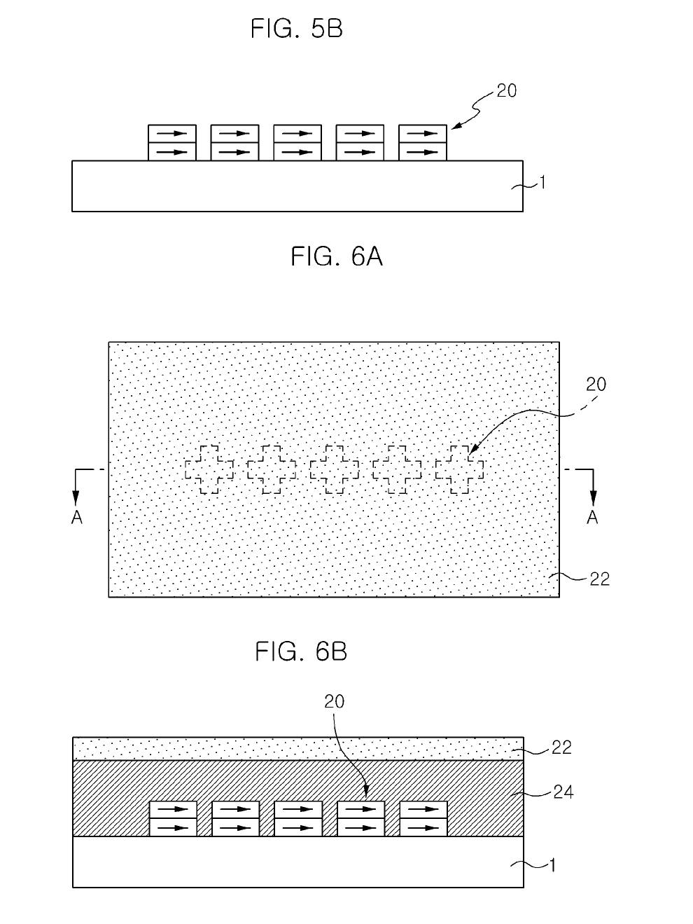

FIGS. 5 to 14 are diagrams for illustrating a structure and a manufacturing process of a cross-type magnetic array sensor for biomolecules bead detection according to a first embodiment of the present invention.

First, as shown in FIGS. 5A and 5B, a giant magnetoresistance thin film is deposited on a substrate 1 and etched, and a plurality of cross-type magnetoresistance devices 20 are arrayed. In other words, the cross-type magnetoresistance devices 20 having a diameter of 100 nm to 100 μm including the giant magnetoresistance thin film having a thickness of 20 nm to 50 nm are arrayed on the silicon single crystalline substrate 1. The plurality of magnetoresistance devices 20 are arrayed in line with maintaining an equal space therebetween. That is, the magnetoresistance devices 20 have a one-dimensional array structure. The substrate 1 as the Si single crystalline substrate includes a substrate including a SiO₂ oxide layer thereon by oxidizing the surface. In the case of etching, a giant magnetoresistance thin film 7 shown in FIG. 3C is selectively etched except for a cross-type part by a dry etching method such as an Ar gas ion milling method or a lift-up method using a negative photosensitive mask. FIG. 5A is a plan view and FIG. 5B is a diagram illustrating an installation pattern between the substrate 1 and the plurality of magnetoresistance devices 20 and is a cross-sectional view taken along line A-A of FIG. 5A.

Thereafter, as shown in FIGS. 6A and 6B, a metal thin film 22 made of Au is deposited on the substrate 1 and the plurality of cross-type magnetoresistance devices 20 via a photosensitive thin film 24. For example, the metal thin film 22 grows up in a thickness of approximately 50 to 300 nm (preferably, a thickness of 150 nm) by a sputtering deposition method at room temperature by applying an argon gas pressure of approximately 3×10⁻⁴ Torr and a sputtering power of approximately 60 W. FIG. 6A is a plan view and FIG. 6B is a diagram illustrating a state in which the metal thin film 22 is deposited and is a cross-sectional view taken along line A-A of FIG. 6A. The metal thin film 22 may be made of Ta.

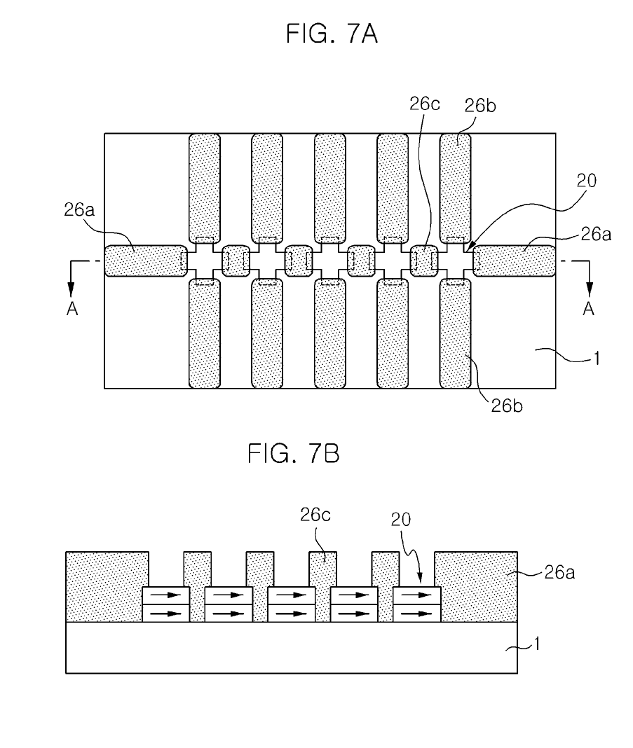

As shown in FIGS. 7A and 7B, a horizontal electrode pad 26a, a vertical electrode pad 26b, and a connection pad 26c are formed. The horizontal electrode pad 26a is used to apply a current, the vertical electrode pad 26b is used to measure a vertical voltage, and the connection pad 26c horizontally connects the plurality of magnetoresistance devices 20 formed in line to each other. In the case of the horizontal electrode pad 26a, the vertical electrode pad 26b, and the connection pad 26c, parts of the metal thin film 22 of FIGS. 6A and 6B except for parts which the electrode pads 26a and 26b and the connection pad 26c will be formed are removed by the dry etching method or the lift-up method using the photosensitive mask. The horizontal electrode pad 26a, the vertical electrode pad 26b, and the connection pad 26c have a thickness of approximately 50 to 300 nm (preferably, a thickness of approximately 150 nm) at room temperature. A line formed when the horizontal electrode pads 26a are horizontally extended to contact each other and a line formed when the vertical electrode pads 26b are vertically extended to contact each other vertically cross each other. FIG. 7A is a plan view and FIG. 7B is a diagram illustrating a state in which the electrode pads 26a and 26b and the connection pad 26c are formed and is a cross-sectional view taken along line A-A of FIG. 7A.

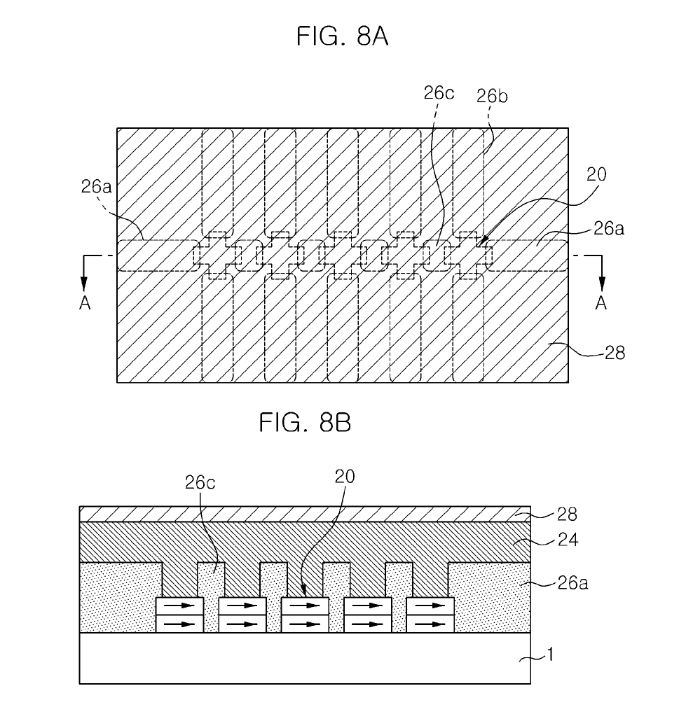

As shown in FIGS. 8A and 8B, an insulating thin-film layer 28 is deposited on the substrate 1, the magnetoresistance devices 20, the electrode pads 26a and 26b, and the connection pad 26c. The insulating thin-film layer 28 is made of SiO₂ or Si₃N₄. The insulating thin-film layer 28 is used to insulate the magnetoresistance devices 20, the electrode pads 26a and 26b, and the connection pad 26c from a corrosion effect of an analysis solution. For example, the insulating thin-film layer 28 made of SiO₂ or Si₃N₄ grows up in a thickness of approximately 50 to 300 nm (preferably, a thickness of 150 nm) by the sputtering deposition method at room temperature by applying the argon gas pressure of approximately 3×10⁻⁴ Torr and the sputtering power of approximately 100 W. FIG. 8A is a plan view and FIG. 8B is a diagram illustrating a state in which the insulating thin-film layer 28 is formed and is a cross-sectional view taken along line A-A of FIG. 8A.

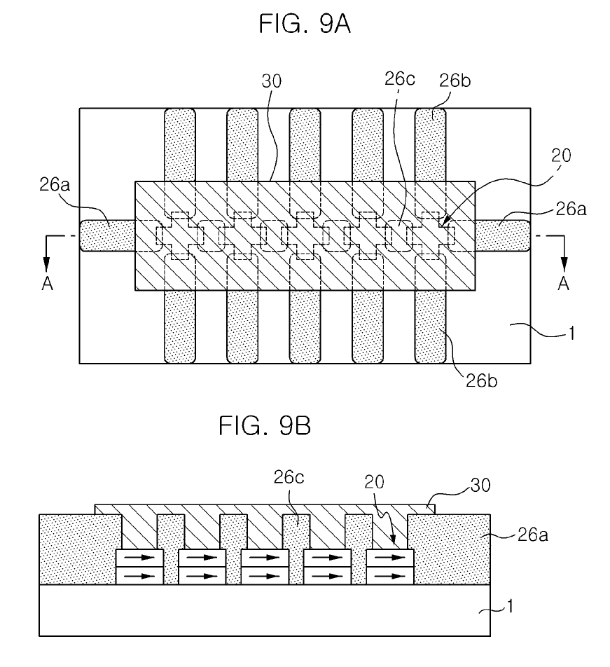

Further, as shown in FIGS. 9A and 9B, an insulating protection layer 30 is formed by partially removing the insulating thin-film layer 28. By the dry etching method such as the Ar gas ion milling method or the lift-up method using the photosensitive mask, the insulating protection layer 30 is formed by removing parts of the insulating thin-film layer 28 except for parts in which the insulating protection layer will be formed. The insulating protection layer 30 has a thickness of approximately 50 to 300 nm (preferably, a thickness of approximately 150 nm). The insulating protection layer 30 is used to insulate the magnetoresistance devices 20, the electrode pads 26a and 26b, and the connection pad 26c from the corrosion effect of the analysis solution. The insulating protection layer 30 is configured unlike the existing structure. The insulating protection layer 30 protects the plurality of magnetoresistance devices 20 and the plurality of electrode pads 26a and 26b and connection pads 26c that are arrayed from corrosion, thereby improving reliability of a product. FIG. 9A is a plan view and FIG. 9B is a diagram illustrating a state in which the insulating protection layer 30 is formed and is a cross-sectional view taken along line A-A of FIG. 9A.

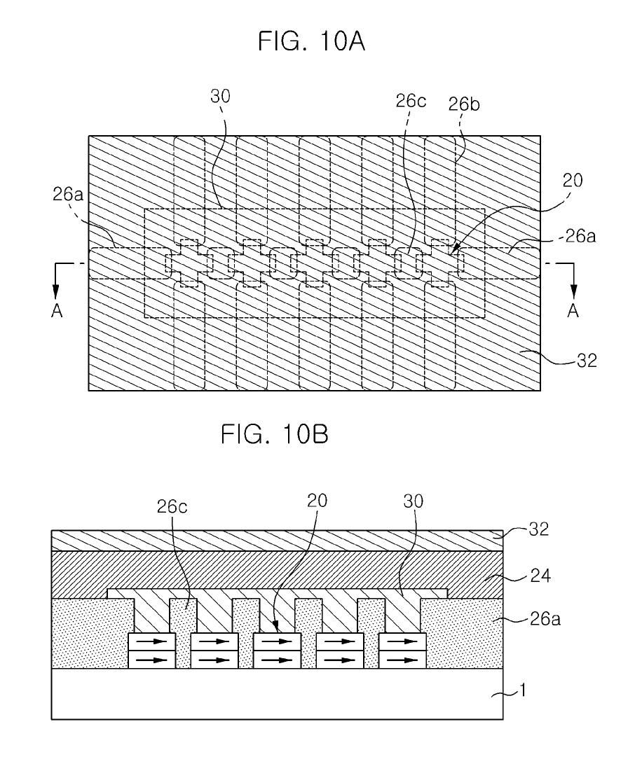

Thereafter, as shown in FIGS. 10A and 10B, an Au metal thin film 32 is deposited on the electrode pads 26a and 26b and the insulating protection layer 30 via the photosensitive thin film 24. The Au metal thin film 32 is used to form a biomolecules fixed layer for fixing biomolecules to the top of the cross-type magnetoresistance device 20. The Au metal thin film 32 grows up in a thickness of approximately 50 to 300 nm (preferably, a thickness of 150 nm) by the sputtering deposition method at room temperature by applying the argon gas pressure of approximately 3×10⁻⁴ Torr and the sputtering power of approximately 100 W. FIG. 10A is a plan view and FIG. 10B is a diagram illustrating a state in which the Au metal thin film 32 is formed and is a cross-sectional view taken along line A-A of FIG. 10A.

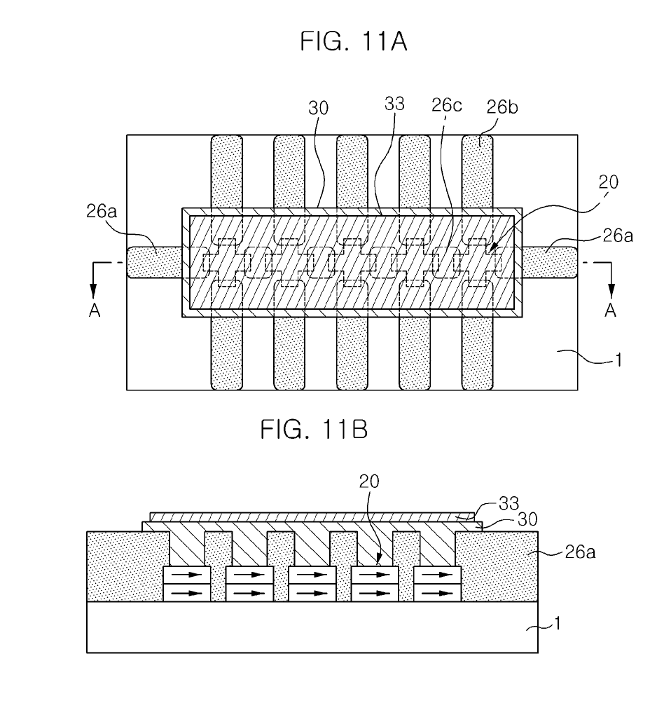

As shown in FIGS. 11A and 11B, the biomolecules fixed layer 33 is formed by selectively removing the Au metal thin film 32. By the dry etching method such as the Ar gas ion milling method or the lift-up method using the photosensitive mask, the biomolecules fixed layer 33 is formed by removing parts of the Au metal thin film 32 except for parts in which the biomolecules fixed layer 33 will be formed. That is, the biomolecules fixed layer 33 has a thickness of approximately 50 to 300 nm (preferably, a thickness of approximately 150 nm) at room temperature. The biomolecules fixed layer 33 is configured unlike the existing structure. The biomolecules fixed layer 33 can easily and accurately fix the biomolecules, thereby improving the reliability of the product. FIG. 11A is a plan view and FIG. 11B is a diagram illustrating a state in which the biomolecules fixed layer 33 is formed and is a cross-sectional view taken along line A-A of FIG. 11A.

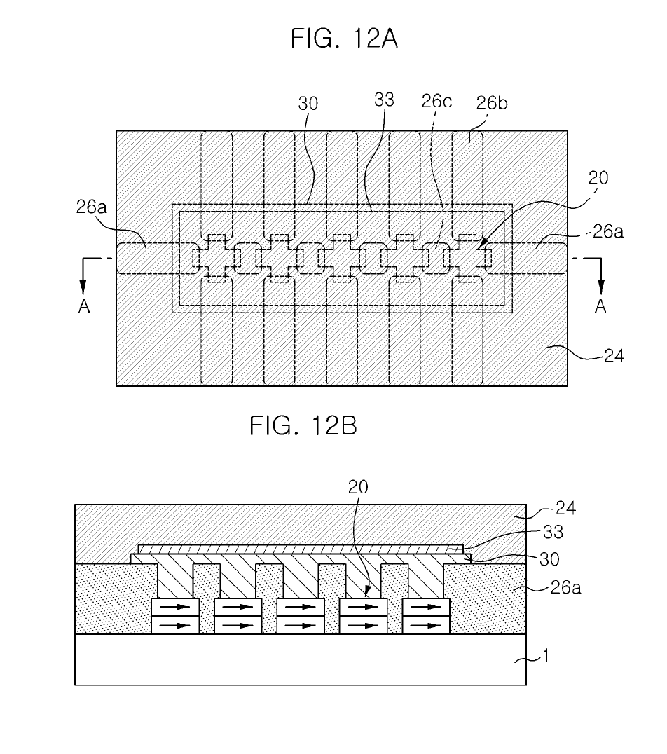

Thereafter, as shown in FIGS. 12A and 12B, the photosensitive thin film 24 is deposited on the electrode pads 26a and 26b, the insulating protection layer 30, and the biomolecules fixed layer 33. FIG. 12A is a plan view and FIG. 12B is a diagram illustrating a state in which the photosensitive thin film 24 is deposited and is a cross-sectional view taken along line A-A of FIG. 12A.

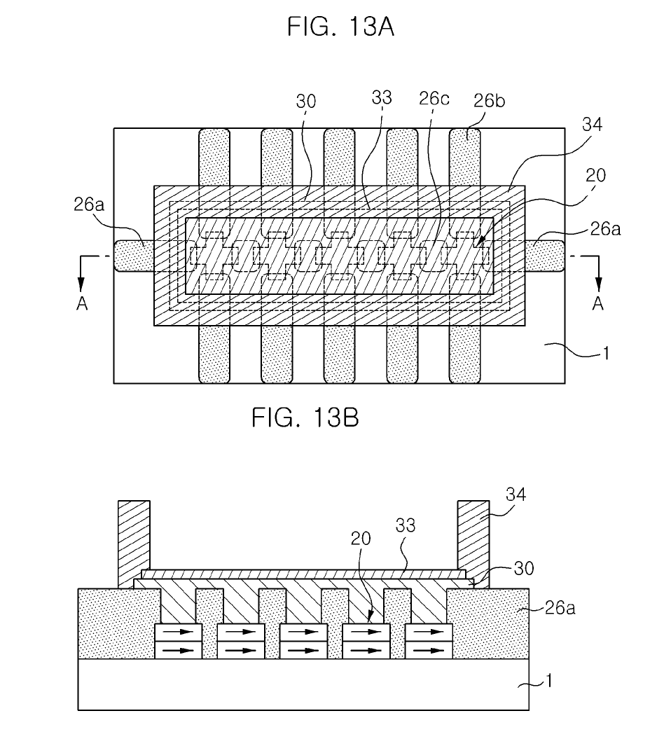

As shown in FIGS. 13A and 13B, a magnetic bead container layer 34 is formed by selectively removing the photosensitive thin film 24 of FIGS. 12A and 12B. The magnetic bead container layer 34 allows a magnetic bead analysis solution (that is, analysis solution containing the magnetic beads) to be positioned adjacent to the magnetoresistance device 20. That is, the magnetic bead container layer 34 positioned on the periphery of the magnetoresistance device 20 coops up the magnetic bead analysis solution. The magnetic bead container layer 34 is formed by a spin coating method so as to have a thickness of approximately 1 to 5 μm at room temperature. The magnetic bead container layer 34 is made of a photosensitive polymer. The magnetic bead container layer 34 is formed by selectively removing parts of the photosensitive thin film 24 of FIGS. 12A and 12B except for parts in which the magnetic bead container layer 34 will be formed by the lift-up method using the negative photosensitive mask. The magnetic bead container layer 34 is configured unlike the existing structure. The magnetic bead container layer 34 further facilitates sensing in the magnetoresistance device 20, thereby improving the reliability of the product. FIG. 13A is a plan view and FIG. 13B is a diagram illustrating a state in which the magnetic bead container layer 34 is formed and is a cross-sectional view taken along line A-A of FIG. 13A.

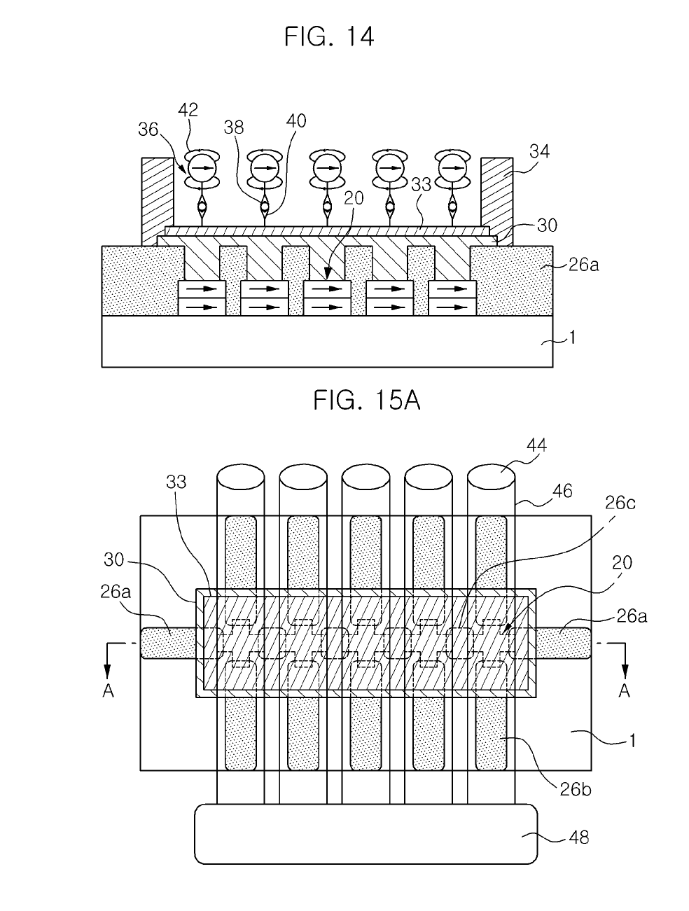

In the case of the cross-type magnetic array sensor for biomolecules magnetic bead detection manufactured by the above-mentioned process, as shown in FIG. 14, when the magnetic bead analysis solution is inputted into the magnetic bead container layer 34, biomolecules 38 attached to the magnetic beads 36 in the magnetic bead analysis solution and biomolecules 40 attached to the biomolecules fixed layer 33 are specifically combined with each other and as a result, the combined biomolecules are fixed onto the plurality of cross-type magnetoresistance device 20. The magnetic beads 36 are magnetized by the magnetic field applied from the outside and as a result, the plurality of cross-type magnetoresistance devices 20 detect the existence of the magnetic beads 36. Alternatively, the magnetic beads 36 that are magnetized by the applied current induction magnetic field generated by the applied current are magnetized and as a result, the plurality of cross-type magnetoresistance devices 20 detect the existence of the magnetic beads 36. In FIG. 14, undescribed reference numeral 42 represents a magnetic bead stray magnetic-field.

FIGS. 15A and 15B are diagrams illustrating a modified example of a first embodiment of the present invention. Although the magnetic bead container layer 34 is formed so as to allow the magnetic bead analysis solution to be positioned adjacent to the magnetoresistance device 20 in the first embodiment, a magnetic bead analysis moving layer (to be described later) is used instead of the magnetic bead container layer 34 in the modified example of the first embodiment.

The modified example of the first embodiment includes the cross-type magnetoresistance devices 20 having the one-dimensional array that grow up on the first substrate 1, the electrode pads 26a and 26b, and the connection pad 26c. The insulating protection layer 30 is deposited on all the cross-type magnetoresistance devices 20 having the one-dimensional array and some of the electrode pads 26a and 26b. The biomolecules fixed layer 33 is formed on the insulating protection layer 30. A magnetic bead solution inlet 44, a moving channel 46, and an outlet 48 are disposed on the biomolecules fixed layer 33 and are disposed to conform to the placement position of the cross-type magnetoresistance device 20 having the one-dimensional array. That is, one end of the moving channel 46 is connected to the magnetic bead solution inlet 44 and the other end of the moving channel 46 is connected to the outlet 48. Herein, the magnetic bead solution inlet 44, the moving channel 46, and the outlet 48 can be generally named as the magnetic bead analysis moving layer. The magnetic bead analysis moving layer is made of PDMS, PMMA, and an SU-8 polymer. The magnetic beads 36 are injected into the magnetic bead solution inlet 44 and move to the cross-type magnetoresistance devices 20 having the one-dimensional array through the moving channel 46. An output voltage of the cross-type magnetoresistance device 20 having the one-dimensional array is varied by the specific combination of the biomolecules 38 attached to the magnetic beads 36 and the biomolecules 40 fixed to the biomolecules fixed layer 33. Therefore, the existence of the magnetic beads 36 is detected.

### Second Embodiment

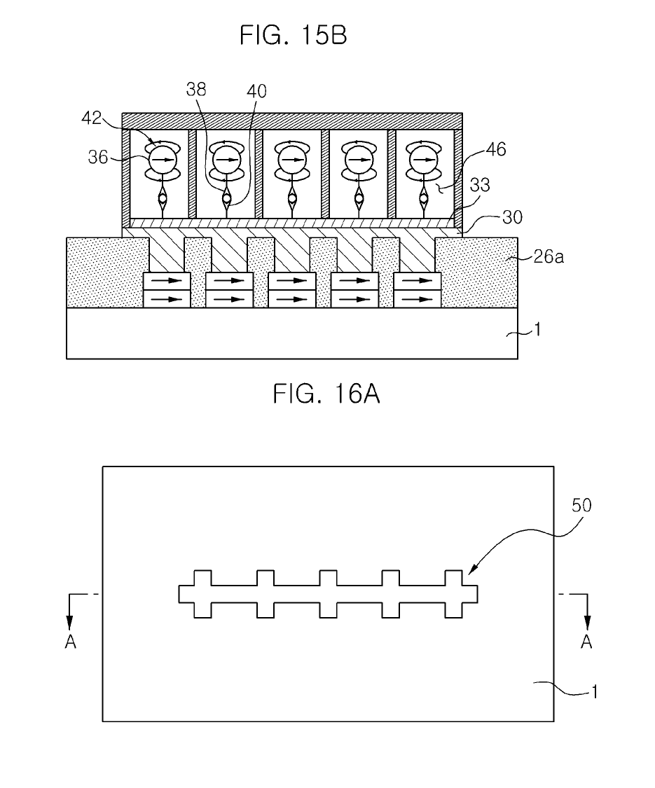

FIGS. 16 to 25 are diagrams for illustrating a structure and a manufacturing process of a cross-type magnetic array sensor for biomolecules magnetic bead detection according to a second embodiment of the present invention. The second embodiment is different from the first embodiment in the shape of the magnetoresistance device. That is, although the plurality of magnetoresistance devices are separated from each other in a cross type and arranged in line in the first embodiment, the plurality of cross-type magnetoresistance devices arranged in line are connected to each other to be integrated in the second embodiment. Meanwhile, the second embodiment is different from the first embodiment in that the connection pad 26c of the first embodiment is not required. Hereinafter, on the basis of this difference, the structure and manufacturing process of the cross-type magnetic array sensor for biomolecules magnetic bead detection according to the second embodiment of the present invention will be described. In addition, in the second embodiment to be described below, the same reference numeral refers to the same elements as the first embodiment.

First, as shown in FIGS. 16A and 16B, a giant magnetoresistance thin film is deposited on the substrate 1 and etched to form a magnetoresistance device 50 having a structure in which the plurality of cross-type magnetoresistance devices are horizontally integrated. In other words, the magnetoresistance device 50 is formed on the silicon single crystalline substrate 1, which has the structure in which the plurality of cross-type magnetoresistance devices having a diameter of 100 nm to 100 μm, which are constituted by the giant magnetoresistance thin film having a thickness of 20 nm to 50 nm are integrated. That is, the magnetoresistance device 50 has the one-dimensional array structure. The substrate 1 as the Si single crystalline substrate includes a substrate in which the surface is oxidized and the SiO₂ oxide layer is formed thereon. In the case of etching, the giant magnetoresistance thin film 7 shown in FIG. 3C is selectively etched except for a cross-type part by the dry etching method such as the Ar gas ion milling method or the lift-up method using the negative photosensitive mask. FIG. 16A is a plan view and FIG. 16B is a diagram illustrating an installation pattern between the substrate 1 and the magnetoresistance device 50 and is a cross-sectional view taken along line A-A of FIG. 16A.

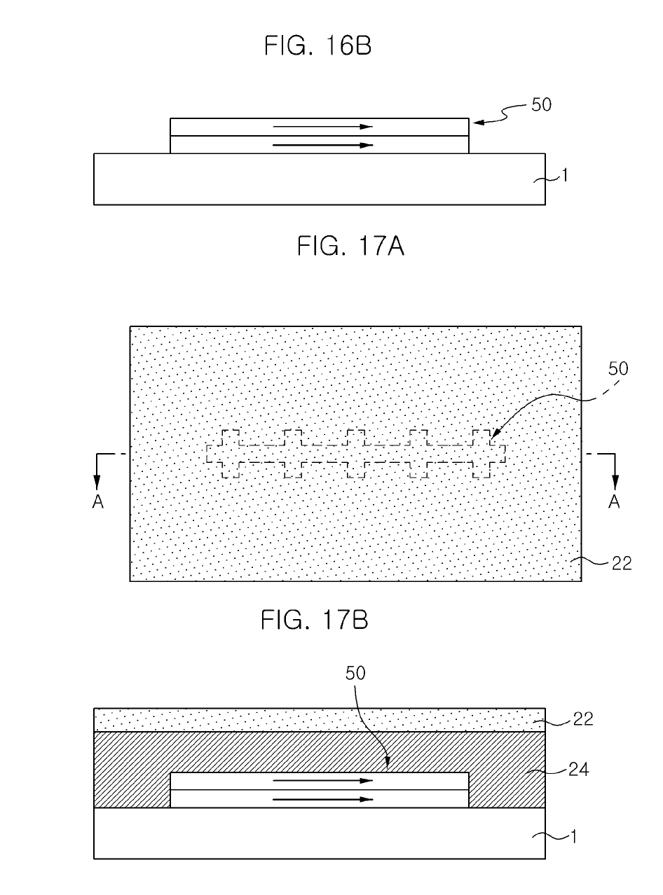

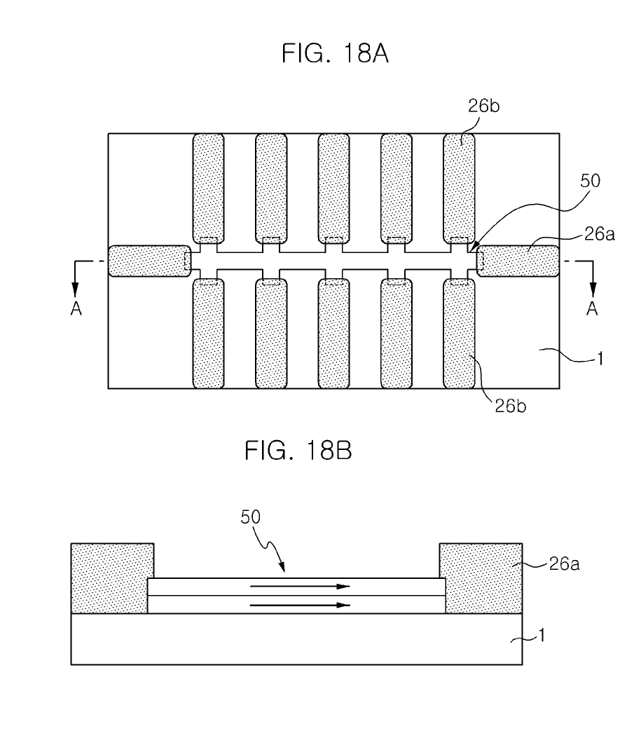

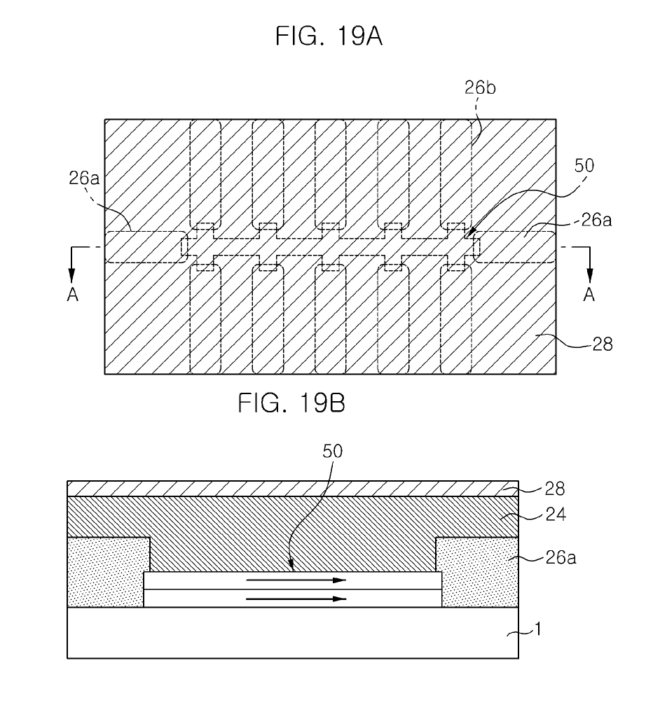

Thereafter, as shown in FIGS. 17A and 17B, the metal thin film 22 made of Au is deposited on the substrate 1 and the magnetoresistance device 50 in which the plurality of cross-type magnetoresistance devices are horizontally integrated via the photosensitive thin film 24. For example, the metal thin film 22 grows up in a thickness of approximately 50 to 300 nm (preferably, a thickness of 150 nm) by the sputtering deposition method at room temperature by applying the argon gas pressure of approximately 3×10⁻⁴ Torr and the sputtering power of approximately 60 W. FIG. 17A is a plan view and FIG. 17B is a diagram illustrating a state in which the metal thin film 22 is deposited and is a cross-sectional view taken along line A-A of FIG. 17A. The metal thin film 22 may be made of Ta.

As shown in FIGS. 18A and 18B, the horizontal electrode pad 26a and the vertical electrode pad 26b are formed. The horizontal electrode pad 26a is used as an electrode for applying the current and the vertical electrode pad 26b is used as an electrode for measuring the vertical voltage. In the case of the horizontal electrode pad 26a and the vertical electrode pad 26b, parts of the metal thin film 22 of FIGS. 17A and 17B except for parts which the electrode pads 26a and 26b will be formed are removed by the dry etching method or the lift-up method using the negative photosensitive mask. The horizontal electrode pad 26a and the vertical electrode pad 26b have a thickness of approximately 50 to 300 nm (preferably, a thickness of approximately 150 nm) at room temperature. A line formed when the horizontal electrode pads 26a are horizontally extended to contact each other and a line formed when the vertical electrode pads 26b are vertically extended to contact each other vertically cross each other. FIG. 18A is a plan view and FIG. 18B is a diagram illustrating a state in which the electrode pads 26a and 26b are formed and is a cross-sectional view taken along line A-A of FIG. 18A.

As shown in FIGS. 19A and 19B, the insulating thin film 28 is deposited on the substrate 1, the magnetoresistance devices 50, and the electrode pads 26a and 26b. The insulating thin film 28 is made of SiO₂ or Si₃N₄. The insulating thin film 28 is used to insulate the magnetoresistance devices 50 and the electrode pads 26a and 26b from the corrosion effect of the analysis solution. For example, the insulating thin film 28 made of SiO₂ or Si₃N₄ grows up in a thickness of approximately 50 to 300 nm (preferably, a thickness of approximately 150 nm) by the sputtering deposition method at room temperature by applying the argon gas pressure of approximately 3×10⁻⁴ Torr and the sputtering power of approximately 100 W. FIG. 19A is a plan view and FIG. 19B is a diagram illustrating a state in which the insulating thin film 28 is formed and is a cross-sectional view taken along line A-A of FIG. 19A.

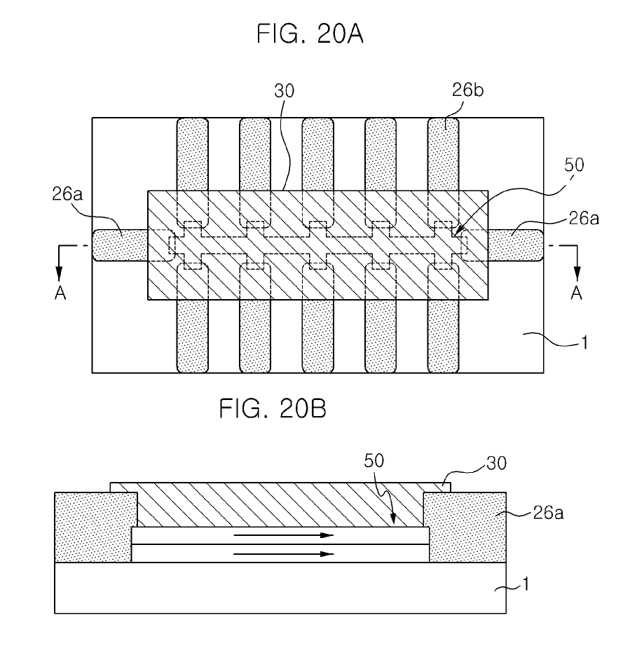

Further, as shown in FIGS. 20A and 20B, the insulating protection layer 30 is formed by partially removing the insulating thin film 28. By the dry etching method such as the Ar gas ion milling method or the lift-up method using the negative photosensitive mask, the insulating protection layer 30 is formed by removing parts of the insulating thin-film layer 28 except for parts in which the insulating protection layer will be formed. The insulating protection layer 30 has a thickness of approximately 50 to 300 nm (preferably, a thickness of approximately 150 nm) at room temperature. The insulating protection layer 30 is used to insulate the magnetoresistance devices 50 and the electrode pads 26a and 26b from the corrosion effect of the analysis solution. The insulating protection layer 30 is configured unlike the existing structure. The insulating protection layer 30 protects the plurality of magnetoresistance devices 50 and the plurality of electrode pads 26a and 26b from the corrosion, thereby improving reliability of the product. FIG. 20A is a plan view and FIG. 20B is a diagram illustrating a state in which the insulating protection layer 30 is formed and is a cross-sectional view taken along line A-A of FIG. 20A.

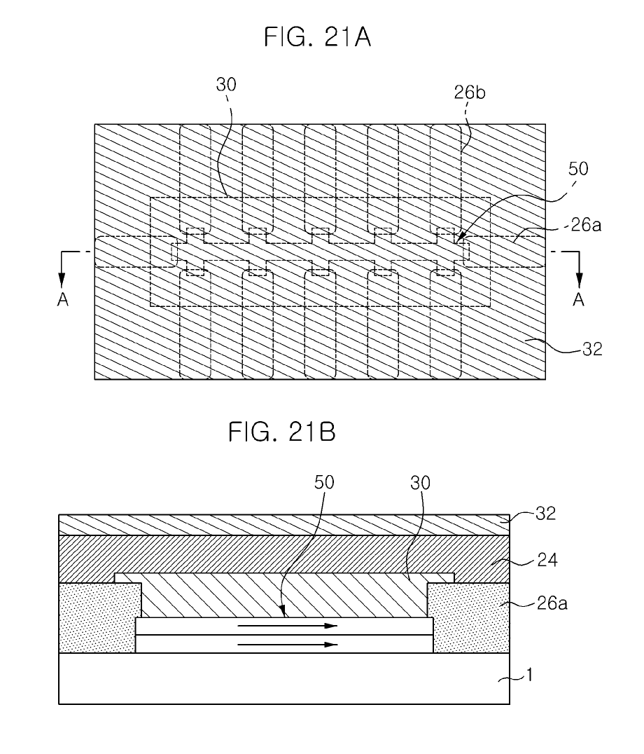

Thereafter, as shown in FIGS. 21A and 21B, the Au metal thin film 32 is deposited on the electrode pads 26a and 26b and the insulating protection layer 30 via the photosensitive thin film 24. The Au metal thin film 32 is used to form the biomolecules fixed layer for fixing the biomolecules to the top of the magnetoresistance device 50. The Au metal thin film 32 grows up in a thickness of approximately 50 to 300 nm (preferably, a thickness of 150 nm) by the sputtering deposition method at room temperature by applying the argon gas pressure of approximately 3×10⁻⁴ Torr and the sputtering power of approximately 100 W. FIG. 21A is a plan view and FIG. 21B is a diagram illustrating a state in which the Au metal thin film 32 is formed and is a cross-sectional view taken along line A-A of FIG. 21A.

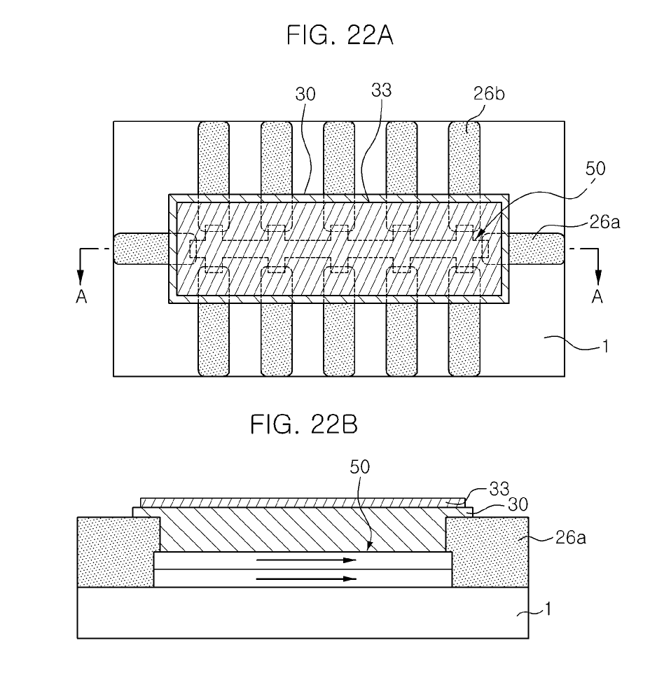

As shown in FIGS. 22A and 22B, the biomolecules fixed layer 33 is formed by selectively removing the Au metal thin film 32. By the dry etching method such as the Ar gas ion milling method or the lift-up method using the negative photosensitive mask, the biomolecules fixed layer 33 is formed by removing parts of the Au metal thin film 32 except for parts in which the biomolecules fixed layer 33 will be formed. That is, the biomolecules fixed layer 33 has a thickness of approximately 50 to 300 nm (preferably, a thickness of approximately 150 nm) at room temperature. The biomolecules fixed layer 33 is configured unlike the existing structure. The biomolecules fixed layer 33 can more easily and accurately fix the biomolecules, thereby improving the reliability of the product. FIG. 22A is a plan view and FIG. 22B is a diagram illustrating a state in which the biomolecules fixed layer 33 is formed and is a cross-sectional view taken along line A-A of FIG. 22A.

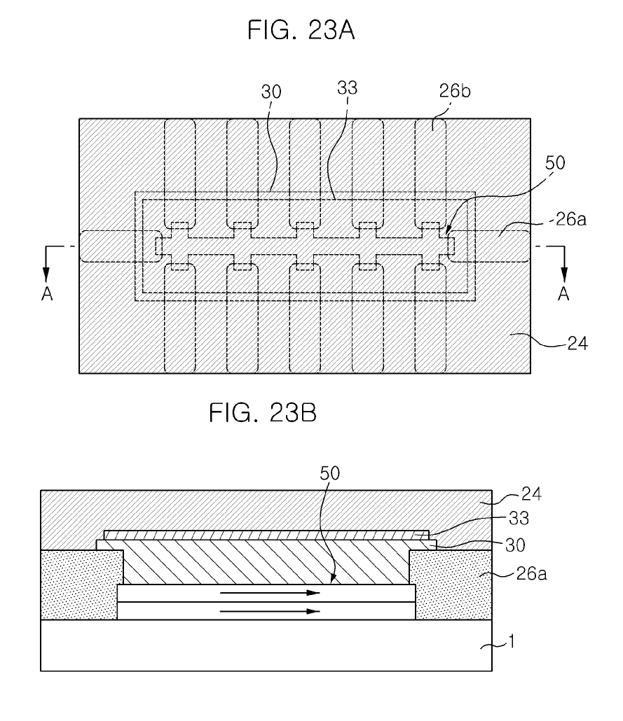

Thereafter, as shown in FIGS. 23A and 23B, the photosensitive thin film 24 is deposited on the electrode pads 26a and 26b, the insulating protection layer 30, and the biomolecules fixed layer 33. FIG. 23A is a plan view and FIG. 23B is a diagram illustrating a state in which the photosensitive thin film 24 is deposited and is a cross-sectional view taken along line A-A of FIG. 23A.

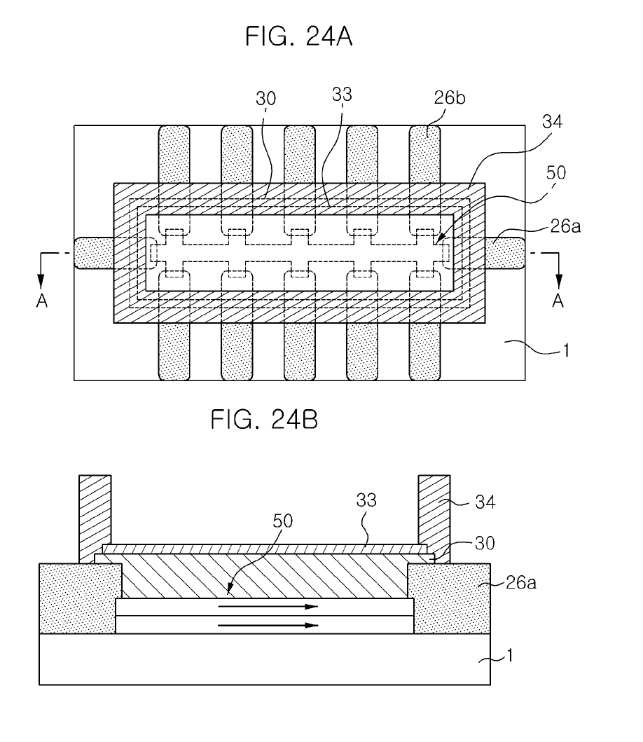

As shown in FIGS. 24A and 24B, the magnetic bead container layer 34 is formed by selectively removing the photosensitive thin film 24 of FIGS. 23A and 23B. The magnetic bead container layer 34 allows the magnetic bead analysis solution (that is, analysis solution containing the magnetic beads) to be positioned adjacent to the magnetoresistance device 50. That is, the magnetic bead container layer 34 positioned on the periphery of the magnetoresistance device 50 coops up the magnetic bead analysis solution. The magnetic bead container layer 34 is formed by the spin coating method so as to have a thickness of approximately 1 to 5 μm. The magnetic bead container layer 34 is made of the photosensitive polymer. The magnetic bead container layer 34 is formed by selectively removing parts of the photosensitive thin film 24 of FIGS. 23A and 23B except for parts in which the magnetic bead container layer 34 will be formed by the lift-up method using the negative photosensitive mask. The magnetic bead container layer 34 is configured unlike the existing structure. The magnetic bead container layer 34 further facilitates sensing in the magnetoresistance device 50, thereby improving the reliability of the product. FIG. 24A is a plan view and FIG. 24B is a diagram illustrating a state in which the magnetic bead container layer 34 is formed and is a cross-sectional view taken along line A-A of FIG. 24A.

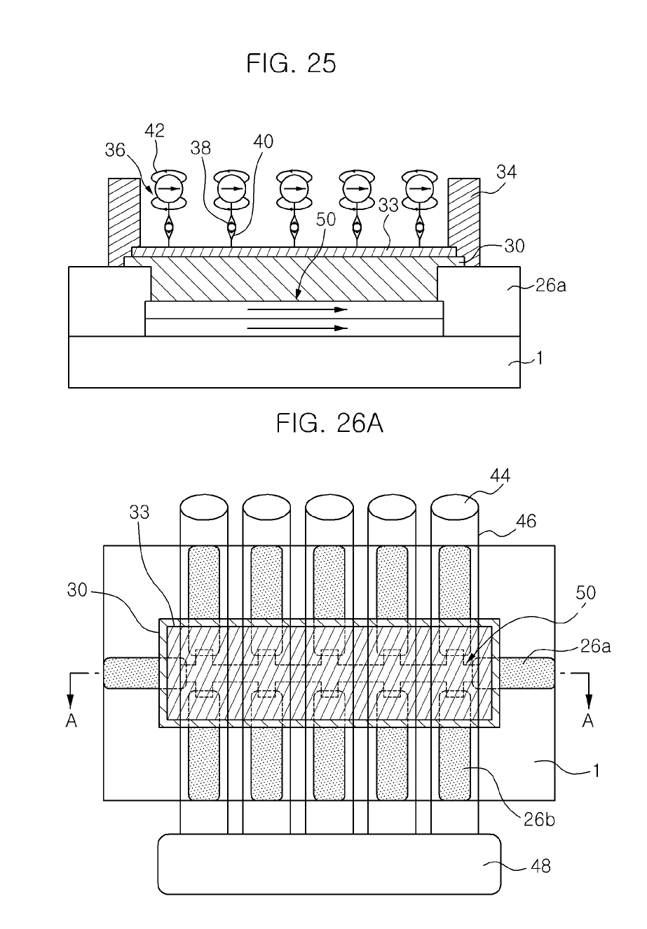

In the case of the cross-type magnetic array sensor for biomolecules magnetic bead detection manufactured by the above-mentioned process, as shown in FIG. 25, when the magnetic bead analysis solution is inputted into the magnetic bead container layer 34, the biomolecules 38 attached to the magnetic beads 36 in the magnetic bead analysis solution and the biomolecules 40 attached to the biomolecules fixed layer 33 are specifically combined with each other and as a result, the combined biomolecules are fixed onto the magnetoresistance device 50 having the structure in which the plurality of cross-type magnetoresistance devices are horizontally integrated. The magnetic beads 36 are magnetized by the magnetic field applied from the outside and as a result, the magnetoresistance device 50 detects the existence of the magnetic beads 36. Alternatively, the magnetic beads 36 that are magnetized by the applied current induction magnetic field generated by the applied current are magnetized and as a result, the magnetoresistance device 50 detects the existence of the magnetic beads 36.

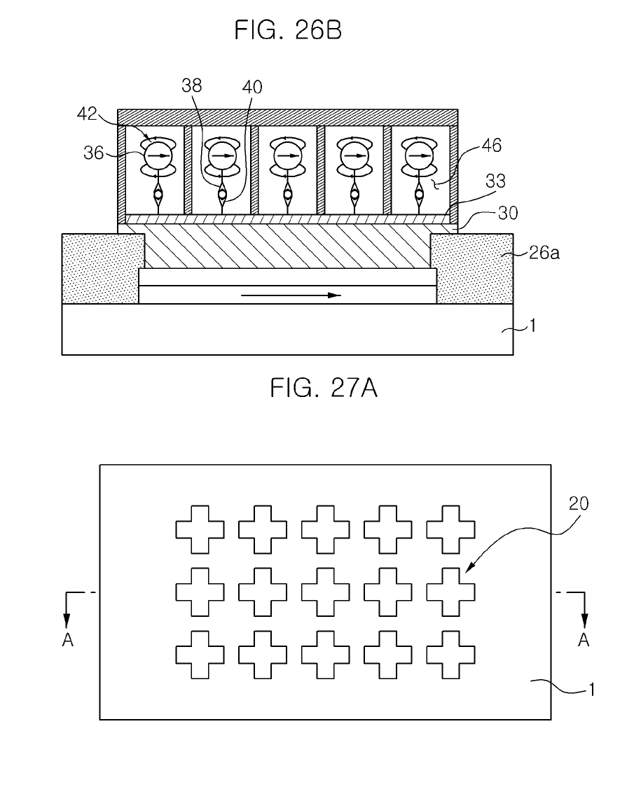

FIGS. 26A and 26B are diagrams illustrating a modified example of a second embodiment of the present invention. Although the magnetic bead container layer 34 is formed so as to allow the magnetic bead analysis solution to be positioned adjacent to the magnetoresistance device 50 in the second embodiment, the magnetic bead analysis moving layer (to be described later) is used instead of the magnetic bead container layer 34 in a modified example of the second embodiment.

The modified example of the second embodiment includes the magnetoresistance devices 50 that grow up on the substrate 1 and the electrode pads 26a and 26b. The insulating protection layer 30 is deposited on all the magnetoresistance devices 50 and some of the electrode pads 26a and 26b. The biomolecules fixed layer 33 is formed on the insulating protection layer 30. The magnetic bead solution inlet 44, the moving channel 46, and the outlet 48 are disposed on the biomolecules fixed layer 33 and are disposed to conform to the placement position (that is, the position of each magnetoresistance device when the plurality of integrated magnetoresistance devices are separated one by one for each unit device) of the magnetoresistance device 50. That is, one end of the moving channel 46 is connected to the magnetic bead solution inlet 44 and the other end of the moving channel 46 is connected to the outlet 48. Herein, the magnetic bead solution inlet 44, the moving channel 46, and the outlet 48 can be generally named as the magnetic bead analysis moving layer. The magnetic bead analysis moving layer is made of PDMS, PMMA, and the SU-8 polymer. The magnetic beads 36 in the analysis solution are injected into the magnetic bead solution inlet 44 and move to the magnetoresistance devices 50 through the moving channel 46. The output voltage of the magnetoresistance device 50 is varied by the specific combination of the biomolecules 38 attached to the magnetic beads 36 and the biomolecules 40 fixed to the biomolecules fixed layer 33. Therefore, the existence of the magnetic beads 36 is detected.

### Third Embodiment

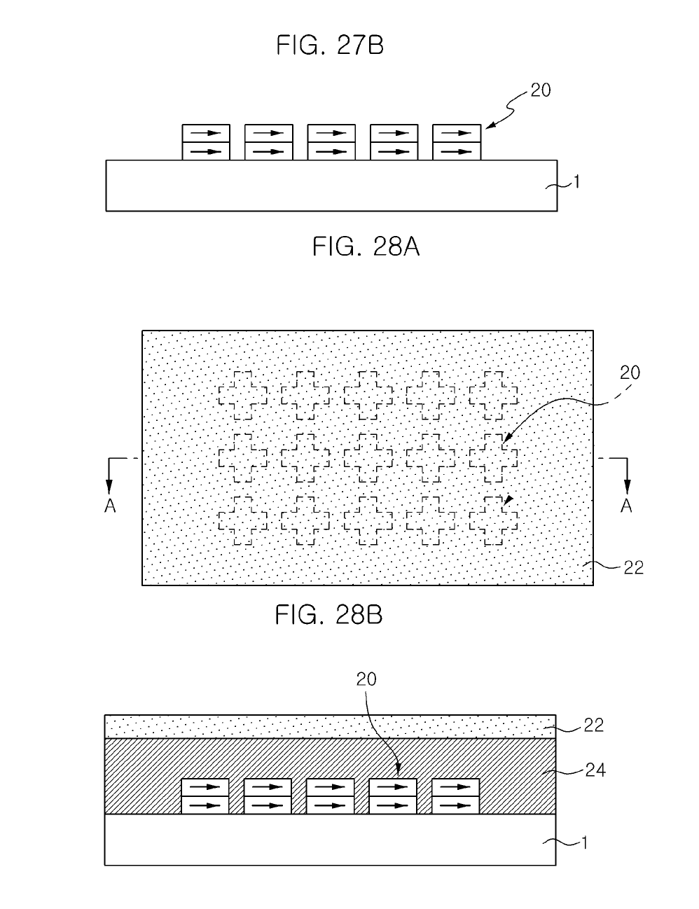

FIGS. 27 to 36 are diagrams for illustrating a structure and a manufacturing process of a cross-type magnetic array sensor for biomolecules bead detection according to a third embodiment of the present invention. Although the plurality of cross-type magnetoresistance devices are formed in the one-dimensional array, the third embodiment is different from the first embodiment in that the plurality of cross-type magnetoresistance devices are formed in a two-dimensional array. Hereinafter, on the basis of this difference, the structure and manufacturing process of the cross-type magnetic array sensor for biomolecules magnetic bead detection according to the third embodiment of the present invention will be described. In addition, in the third embodiment to be described below, the same reference numeral refers to the same elements as the first embodiment.

First, as shown in FIGS. 27A and 27B, the giant magnetoresistance thin film is deposited on the substrate 1 and etched, and a plurality of cross-type magnetoresistance devices 20 are arrayed. In other words, the cross-type magnetoresistance devices 20 having a diameter of 100 nm to 100 μm including the giant magnetoresistance thin film having a thickness of 20 nm to 50 nm are arrayed on the silicon single crystalline substrate 1. The plurality of magnetoresistance devices 20 are arrayed in line with maintaining an equal space therebetween. That is, the magnetoresistance device 50 has the two-dimensional array structure. The substrate 1 as the Si single crystalline substrate includes a substrate in which the surface is oxidized and the SiO₂ oxide layer is formed thereon. In the case of etching, the giant magnetoresistance thin film 7 shown in FIG. 3C is selectively etched except for a cross-type part by the dry etching method such as the Ar gas ion milling method or the lift-up method using the negative photosensitive mask. FIG. 27A is a plan view and FIG. 27B is a diagram illustrating an installation pattern between the substrate 1 and the magnetoresistance device 20 and is a cross-sectional view taken along line A-A of FIG. 27A.

Thereafter, as shown in FIGS. 28A and 28B, the metal thin film 22 made of Au is deposited on the substrate 1 and the magnetoresistance devices 20 of the two-dimensional array via the photosensitive thin film 24. For example, the metal thin film 22 grows up in a thickness of approximately 50 to 300 nm (preferably, a thickness of 150 nm) by the sputtering deposition method at room temperature by applying the argon gas pressure of approximately 3×10⁻⁴ Torr and the sputtering power of approximately 60 W. FIG. 28A is a plan view and FIG. 28B is a diagram illustrating a state in which the metal thin film 22 is deposited and is a cross-sectional view taken along line A-A of FIG. 28A. The metal thin film 22 may be made of Ta.

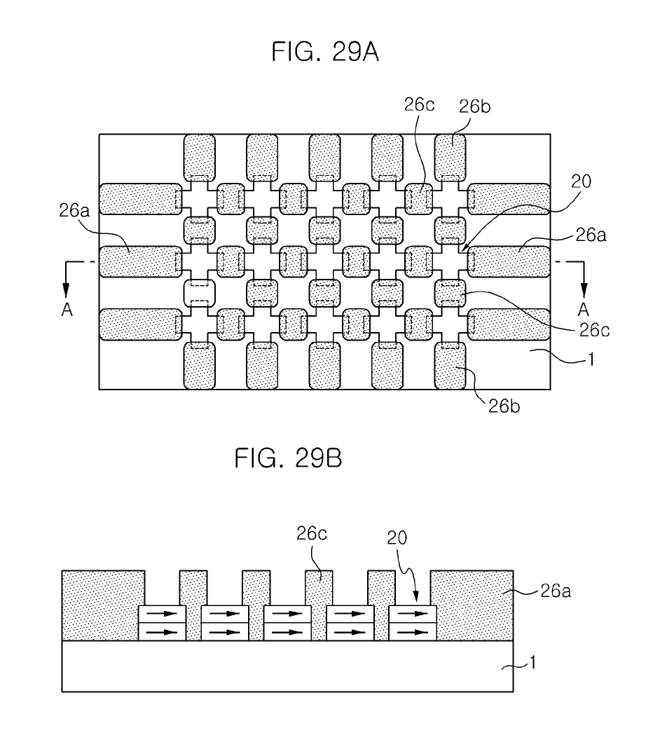

As shown in FIGS. 29A and 29B, the horizontal electrode pad 26a, the vertical electrode pad 26b, and the connection pad 26c are formed. The horizontal electrode pad 26a is used as the electrode for applying the current, the vertical electrode pad 26b is used as the electrode for measuring the vertical voltage, and the connection pad 26c horizontally and vertically connects the plurality of magnetoresistance devices 20 of the two-dimensional array to each other. In the case of the horizontal electrode pad 26a, the vertical electrode pad 26b, and the connection pad 26c, parts of the metal thin film 22 of FIGS. 28A and 28B except for parts which the electrode pads 26a and 26b and the connection pad 26c will be formed are removed by the dry etching method or the lift-up method using the negative photosensitive mask. The horizontal electrode pad 26a, the vertical electrode pad 26b, and the connection pad 26c have a thickness of approximately 50 to 300 nm (preferably, a thickness of approximately 150 nm) at room temperature. The line formed when the horizontal electrode pads 26a are horizontally extended to contact each other and the line formed when the vertical electrode pads 26b are vertically extended to contact each other vertically cross each other. FIG. 29A is a plan view and FIG. 29B is a diagram illustrating a state in which the electrode pads 26a and 26b and the connection pad 26c are formed and is a cross-sectional view taken along line A-A of FIG. 29A.

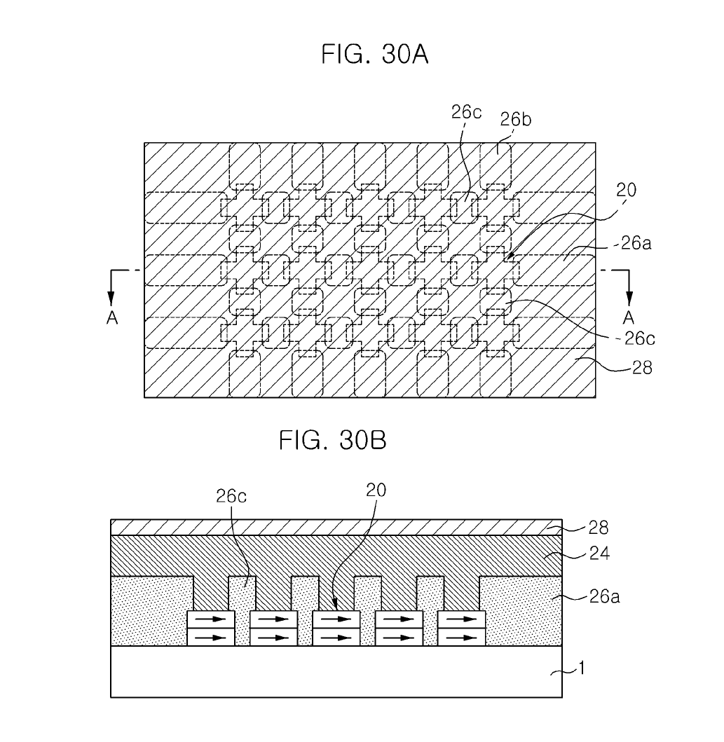

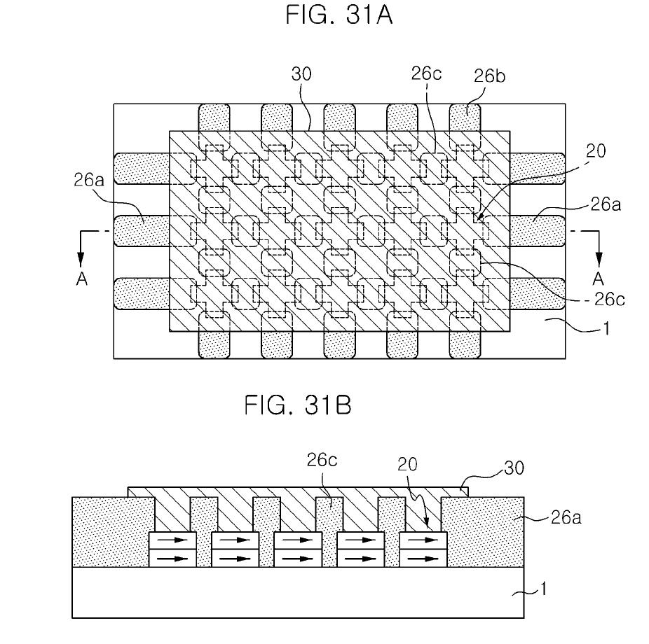

As shown in FIGS. 30A and 30B, the insulating thin film 28 is deposited on the substrate 1, the magnetoresistance devices 20, the electrode pads 26a and 26b, and the connection pad 26c. The insulating thin film 28 is made of SiO₂ or Si₃N₄. The insulating thin film 28 is used to insulate the magnetoresistance devices 20, the electrode pads 26a and 26b, and the connection pad 26c from the corrosion effect of the analysis solution. For example, the insulating thin film 28 made of SiO₂ or Si₃N₄ grows up in a thickness of approximately 50 to 300 nm (preferably, a thickness of approximately 150 nm) by the sputtering deposition method at room temperature by applying the argon gas pressure of approximately 3×10⁻⁴ Torr and the sputtering power of approximately 100 W. FIG. 30A is a plan view and FIG. 30B is a diagram illustrating a state in which the insulating thin film 28 is formed and is a cross-sectional view taken along line A-A of FIG. 30A.

Further, as shown in FIGS. 31A and 31B, the insulating protection layer 30 is formed by partially removing the insulating thin film 28. By the dry etching method such as the Ar gas ion milling method or the lift-up method using the negative photosensitive mask, the insulating protection layer 30 is formed by removing parts of the insulating thin-film layer 28 except for parts in which the insulating protection layer will be formed. The insulating protection layer 30 has a thickness of approximately 50 to 300 nm (preferably, a thickness of approximately 150 nm) at room temperature. The insulating thin film 30 is used to insulate the magnetoresistance devices 20, the electrode pads 26a and 26b, and the connection pad 26c from the corrosion effect of the analysis solution. The insulating protection layer 30 is configured unlike the existing structure. The insulating protection layer 30 protects the plurality of magnetoresistance devices 20 and the plurality of electrode pads 26a and 26b and connection pads 26c that are arrayed from the corrosion, thereby improving the reliability of the product. FIG. 31A is a plan view and FIG. 31B is a diagram illustrating a state in which the insulating protection layer 30 is formed and is a cross-sectional view taken along line A-A of FIG. 31A.

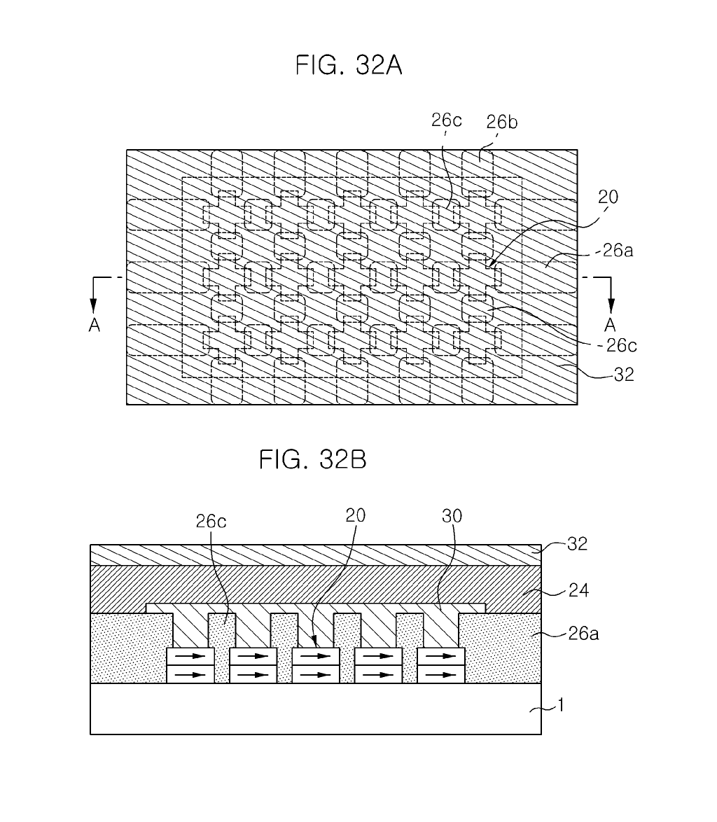

Thereafter, as shown in FIGS. 32A and 32B, the Au metal thin film 32 is deposited on the electrode pads 26a and 26b and the insulating protection layer 30 via the photosensitive thin film 24. The Au metal thin film 32 is used to form the biomolecules fixed layer for fixing biomolecules to the top of the magnetoresistance device 20 of the two-dimensional array. The Au metal thin film 32 grows up in a thickness of approximately 50 to 300 nm (preferably, a thickness of 150 nm) by the sputtering deposition method at room temperature by applying the argon gas pressure of approximately 3×10⁻⁴ Torr and the sputtering power of approximately 100 W. FIG. 32A is a plan view and FIG. 32B is a diagram illustrating a state in which the Au metal thin film 32 is formed and is a cross-sectional view taken along line A-A of FIG. 32A.

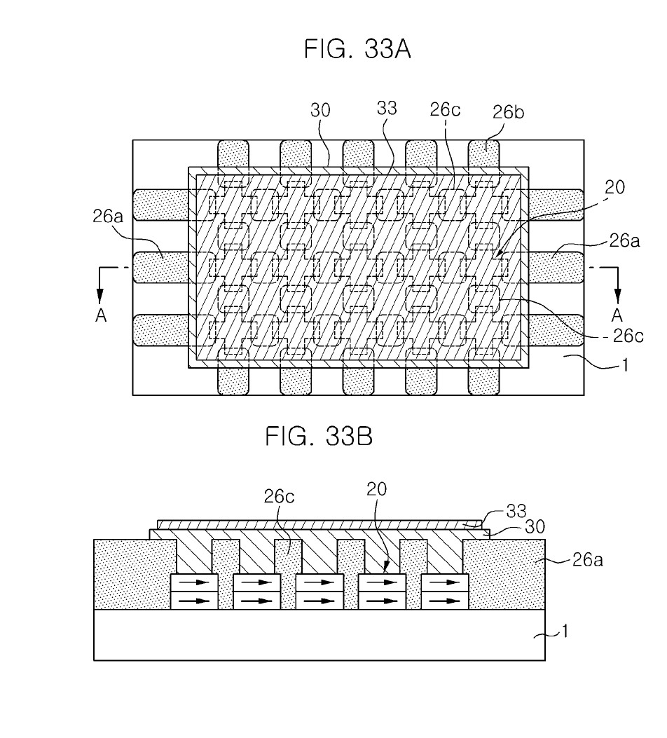

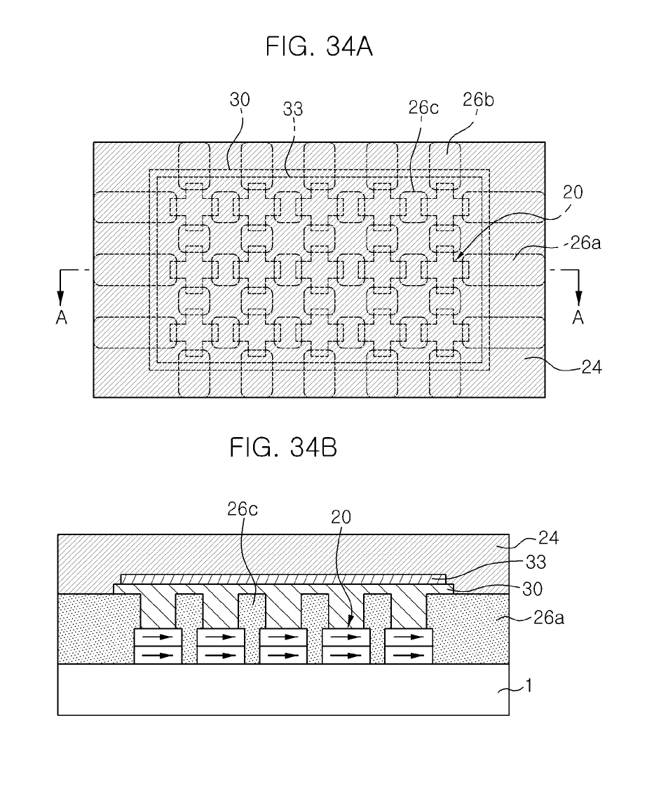

As shown in FIGS. 33A and 33B, the biomolecules fixed layer 33 is formed by selectively removing the Au metal thin film 32. By the dry etching method such as the Ar gas ion milling method or the lift-up method using the negative photosensitive mask, the biomolecules fixed layer 33 is formed by removing parts of the Au metal thin film 32 except for parts in which the biomolecules fixed layer 33 will be formed. That is, the biomolecules fixed layer 33 has a thickness of approximately 50 to 300 nm (preferably, a thickness of approximately 150 nm) at room temperature. The biomolecules fixed layer 33 is configured unlike the existing structure. The biomolecules fixed layer 33 can more easily and accurately fix the biomolecules, thereby improving the reliability of the product. FIG. 33A is a plan view and FIG. 33B is a diagram illustrating a state in which the biomolecules fixed layer 33 is formed and is a cross-sectional view taken along line A-A of FIG. 33A.

Thereafter, as shown in FIGS. 34A and 34B, the photosensitive thin film 24 is deposited on the electrode pads 26a and 26b, the insulating protection layer 30, and the biomolecules fixed layer 33. FIG. 34A is a plan view and FIG. 34B is a diagram illustrating a state in which the photosensitive thin film 24 is deposited and is a cross-sectional view taken along line A-A of FIG. 34A.

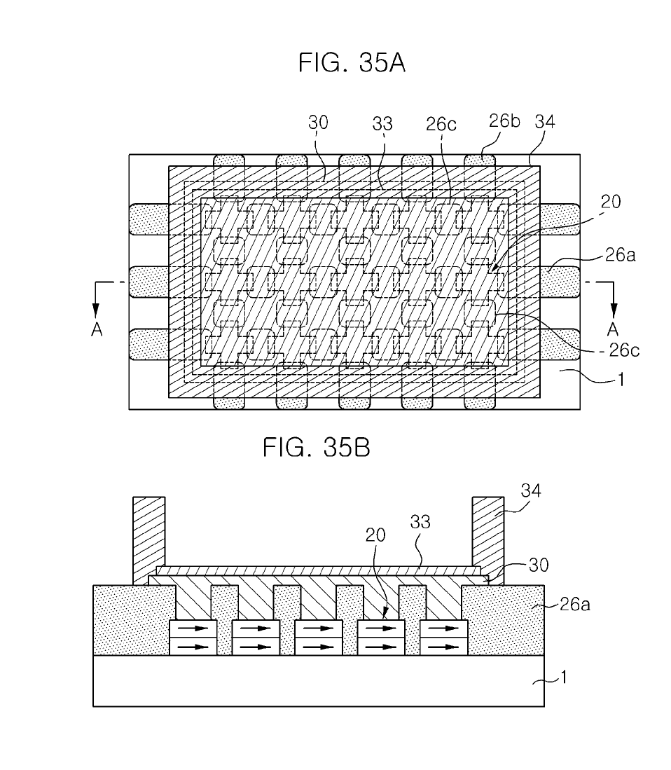

As shown in FIGS. 35A and 35B, the magnetic bead container layer 34 is formed by selectively removing the photosensitive thin film 24 of FIGS. 34A and 34B. The magnetic bead container layer 34 allows the magnetic bead analysis solution (that is, analysis solution containing the magnetic beads) to be positioned adjacent to the magnetoresistance device 20. That is, the magnetic bead container layer 34 positioned on the periphery of the magnetoresistance device 20 coops up the magnetic bead analysis solution. The magnetic bead container layer 34 is formed by the spin coating method so as to have a thickness of approximately 1 to 5μm. The magnetic bead container layer 34 is made of the photosensitive polymer. The magnetic bead container layer 34 is formed by selectively removing parts of the photosensitive thin film 24 of FIGS. 34A and 34B except for parts in which the magnetic bead container layer 34 will be formed by the lift-up method using the negative photosensitive mask. The magnetic bead container layer 34 is configured unlike the existing structure. The magnetic bead container layer 34 further facilitates sensing in the magnetoresistance device 20, thereby improving the reliability of the product. FIG. 35A is a plan view and FIG. 35B is a diagram illustrating a state in which the magnetic bead container layer 34 is formed and is a cross-sectional view taken along line A-A of FIG. 35A.

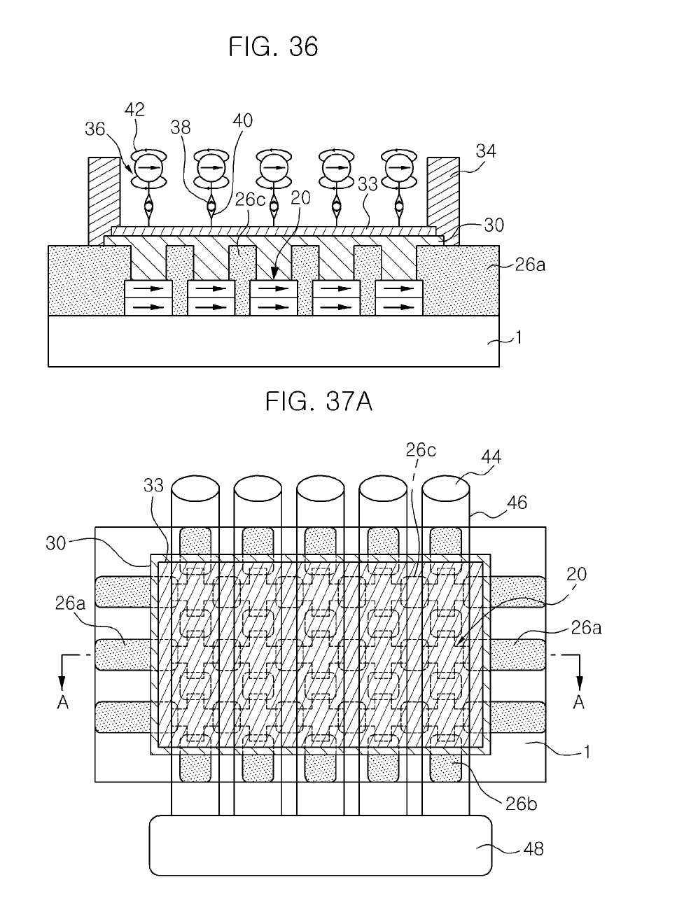

In the case of the cross-type magnetic array sensor for biomolecules magnetic bead detection manufactured by the above-mentioned process, as shown in FIG. 36, when the magnetic bead analysis solution is inputted into the magnetic bead container layer 34, biomolecules 38 attached to the magnetic beads 36 in the magnetic bead analysis solution and biomolecules 40 attached to the biomolecules fixed layer 33 are specifically combined with each other and as a result, the combined biomolecules are fixed onto the cross-type magnetoresistance device 20 of the two-dimensional array. The magnetic beads 36 are magnetized by the magnetic field applied from the outside and as a result, the cross-type magnetoresistance device 20 of the two dimensional array detects the existence of the magnetic beads 36. Alternatively, the magnetic beads 36 that are magnetized by the applied current induction magnetic field generated by the applied current are magnetized and as a result, the cross-type magnetoresistance devices 20 of the two-dimensional array detect the existence of the magnetic beads 36.

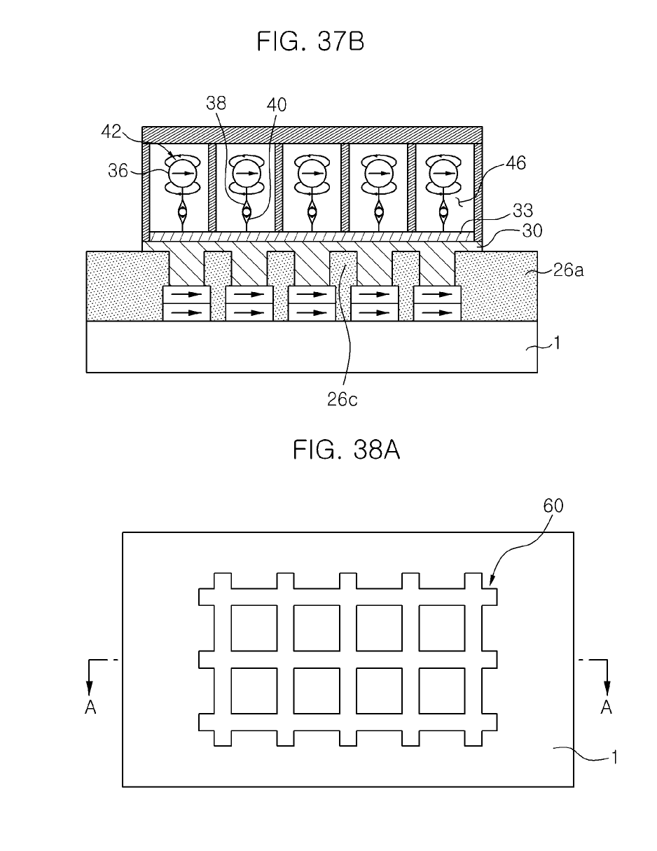

FIGS. 37A and 37B are diagrams illustrating a modified example of a third embodiment of the present invention. Although the magnetic bead container layer 34 is formed so as to allow the magnetic bead analysis solution to be positioned adjacent to the magnetoresistance device 20 of the two-dimensional array in the third embodiment, the magnetic bead analysis moving layer (to be described later) is used instead of the magnetic bead container layer 34 in the modified example of the third embodiment.

The modified example of the third embodiment includes the cross-type magnetoresistance devices 20 having the two-dimensional array that grow up on the substrate 1, the electrode pads 26a and 26b, and the connection pad 26c. The insulating protection layer 30 is deposited on all the cross-type magnetoresistance devices 20 having the two-dimensional array and some of the electrode pads 26a and 26b. The biomolecules fixed layer 33 is formed on the insulating protection layer 30. The magnetic bead solution inlet 44, the moving channel 46, and the outlet 48 are disposed on the biomolecules fixed layer 33 and are disposed, for example, in a vertical direction to the cross-type magnetoresistance device 20 having the two-dimensional array. That is, one end of the moving channel 46 is connected to the magnetic bead solution inlet 44 and the other end of the moving channel 46 is connected to the outlet 48. Herein, the magnetic bead solution inlet 44, the moving channel 46, and the outlet 48 can be generally named as the magnetic bead analysis moving layer. The magnetic bead analysis moving layer is made of PDMS, PMMA, and the SU-8 polymer. The magnetic beads 36 in the analysis solution are injected into the magnetic bead solution inlet 44 and move to the cross-type magnetoresistance devices 20 having the two-dimensional array through the moving channel 46. The output voltage of the cross-type magnetoresistance device 20 having the two-dimensional array is varied by the specific combination of the biomolecules 38 attached to the magnetic beads 36 and the biomolecules 40 fixed to the biomolecules fixed layer 33. Therefore, the existence of the magnetic beads 36 is detected.

### Fourth Embodiment

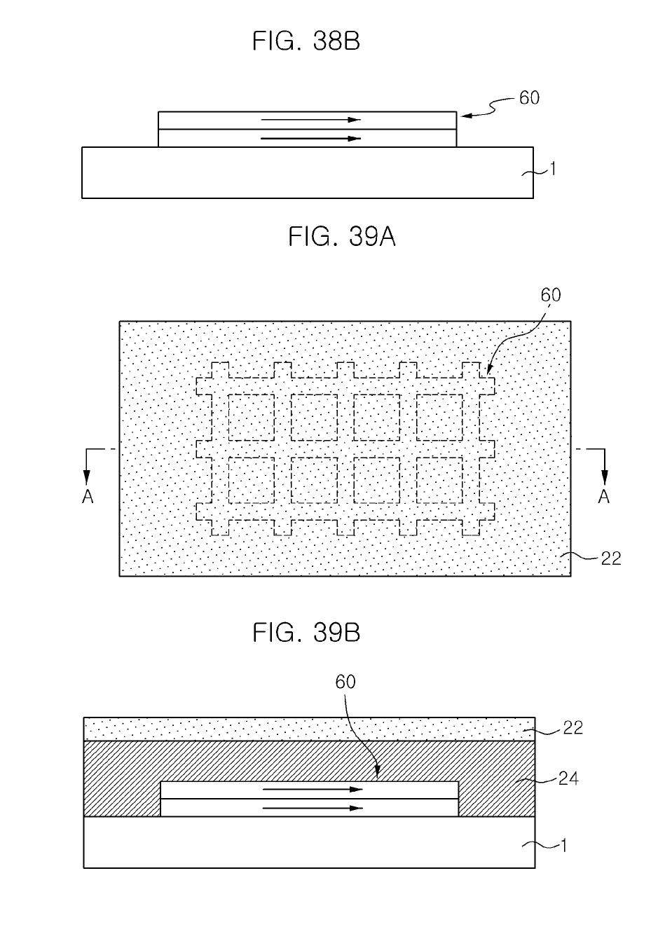

FIGS. 38 to 47 are diagrams for illustrating a structure and a manufacturing process of a cross-type magnetic array sensor for biomolecules bead detection according to a fourth embodiment of the present invention. In the fourth embodiment, the plurality of magnetoresistance devices of the second embodiment are connected to each other. That is, although the plurality of cross-type magnetoresistance devices that are disposed in line are integrated (that is, one-dimensional array structure) in the second embodiment, the one-dimensional integration structure of the second embodiment is changed to a two-dimensional integration structure in the fourth embodiment. Hereinafter, on the basis of this difference, the structure and manufacturing process of the cross-type magnetic array sensor for biomolecules magnetic bead detection according to the fourth embodiment of the present invention will be described. In addition, in the fourth embodiment to be described below, the same reference numeral refers to the same elements as the second embodiment.

First, as shown in FIGS. 38A and 38B, a giant magnetoresistance thin film is deposited on the substrate 1 and etched to form a magnetoresistance device 60 having a structure in which the plurality of cross-type magnetoresistance devices are horizontally and vertically integrated. In other words, the magnetoresistance device 60 having the two-dimensional array is formed on the silicon single crystalline substrate 1, which has the structure in which the plurality of cross-type magnetoresistance devices having a diameter of 100 nm to 100 μm, which are constituted by the giant magnetoresistance thin film having a thickness of 20 nm to 50 nm are integrated. That is, the magnetoresistance device 50 has the two-dimensional array structure. The substrate 1 as the Si single crystalline substrate includes the substrate in which the surface is oxidized and the SiO₂ oxide layer is formed thereon. In the case of etching, the giant magnetoresistance thin film 7 shown in FIG. 3C is selectively etched except for a cross-type part by the dry etching method such as the Ar gas ion milling method or the lift-up method using the negative photosensitive mask. FIG. 38A is a plan view and FIG. 38B is a diagram illustrating an installation pattern between the substrate 1 and the magnetoresistance device 60 and is a cross-sectional view taken along line A-A of FIG. 38A.

Thereafter, as shown in FIGS. 39A and 39B, the metal thin film 22 made of Au is deposited on the substrate 1 and the magnetoresistance device 60 in which the plurality of cross-type magnetoresistance devices are horizontally and vertically integrated via the photosensitive thin film 24. For example, the metal thin film 22 grows up in a thickness of approximately 50 to 300 nm (preferably, a thickness of 150 nm) by the sputtering deposition method at room temperature by applying the argon gas pressure of approximately 3×10⁻⁴ Torr and the sputtering power of approximately 60 W. FIG. 39A is a plan view and FIG. 39B is a diagram illustrating a state in which the metal thin film 22 is deposited and is a cross-sectional view taken along line A-A of FIG. 39A. The metal thin film 22 may be made of Ta.

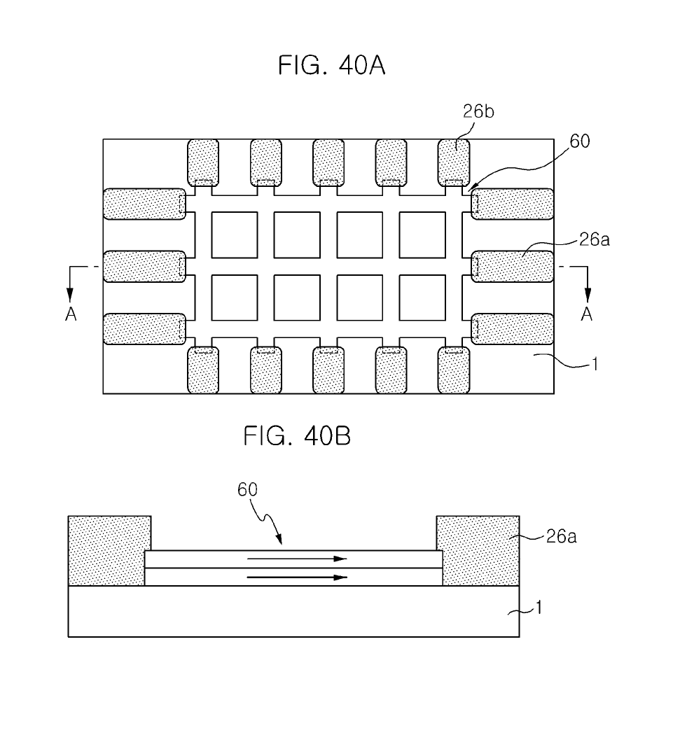

As shown in FIGS. 40A and 40B, the horizontal electrode pad 26a and the vertical electrode pad 26b are formed. The horizontal electrode pad 26a is used as the electrode for applying the current and the vertical electrode pad 26b is used as the electrode for measuring to measure the vertical voltage. In the case of the horizontal electrode pad 26a and the vertical electrode pad 26b, parts of the metal thin film 22 of FIGS. 39A and 39B except for parts which the electrode pads 26a and 26b will be formed are removed by the dry etching method or the lift-up method using the negative photosensitive mask. The horizontal electrode pad 26a and the vertical electrode pad 26b have a thickness of approximately 50 to 300 nm (preferably, a thickness of approximately 150 nm) at room temperature. The line formed when the horizontal electrode pads 26a are horizontally extended to contact each other and the line formed when the vertical electrode pads 26b are vertically extended to contact each other vertically cross each other. FIG. 40A is a plan view and FIG. 40B is a diagram illustrating a state in which the electrode pads 26a and 26b are formed and is a cross-sectional view taken along line A-A of FIG. 40A.

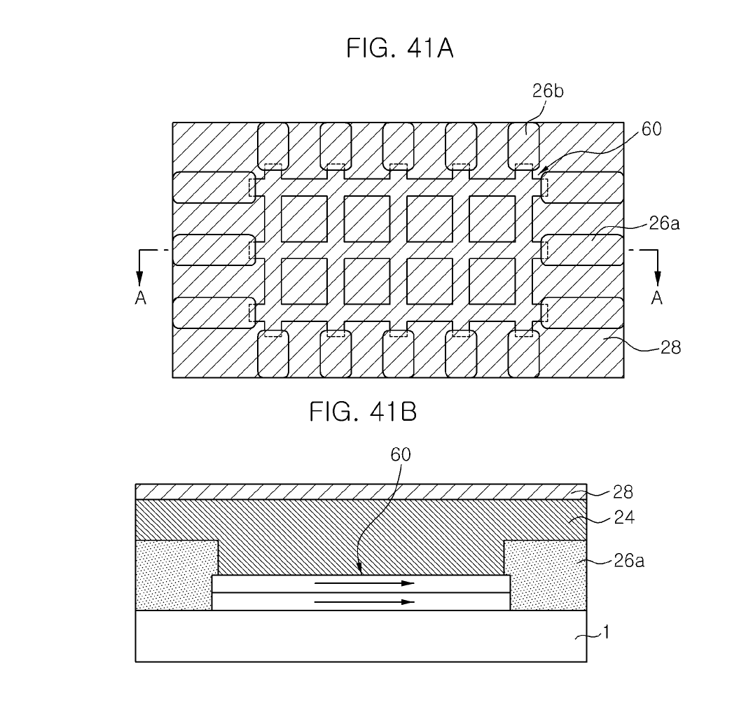

As shown in FIGS. 41A and 41B, the insulating thin film 28 is deposited on the substrate 1, the magnetoresistance devices 60, and the electrode pads 26a and 26b. The insulating thin film 28 is made of SiO₂ or Si₃N₄. The insulating thin film 28 is used to insulate the magnetoresistance devices 60 and the electrode pads 26a and 26b from the corrosion effect of the analysis solution. For example, the insulating thin film 28 made of SiO₂ or Si₃N₄ grows up in a thickness of approximately 50 to 300 nm (preferably, a thickness of approximately 150 nm) by the sputtering deposition method at room temperature by applying the argon gas pressure of approximately 3×10⁻⁴ Torr and the sputtering power of approximately 100 W. FIG. 41A is a plan view and FIG. 41B is a diagram illustrating a state in which the insulating thin film 28 is formed and is a cross-sectional view taken along line A-A of FIG. 41A.

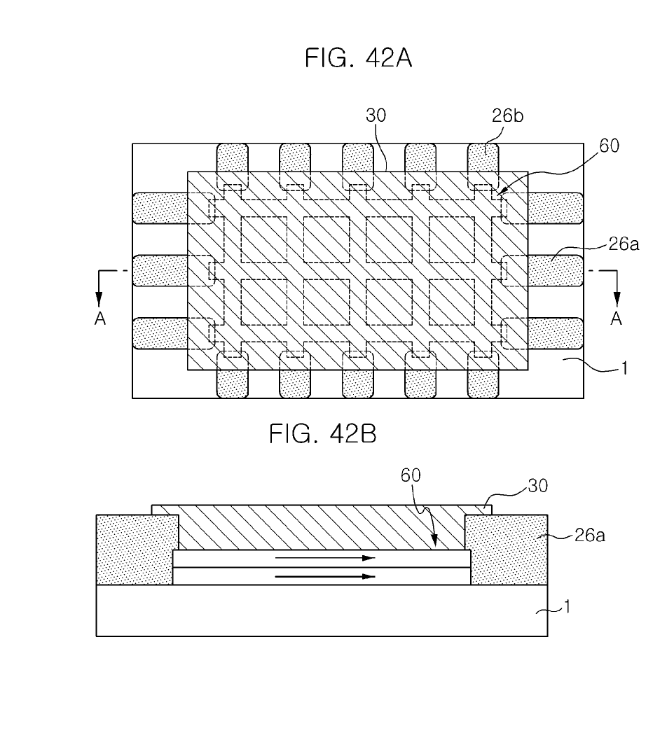

Further, as shown in FIGS. 42A and 42B, the insulating protection layer 30 is formed by partially removing the insulating thin film 28. By the dry etching method such as the Ar gas ion milling method or the lift-up method using the negative photosensitive mask, the insulating protection layer 30 is formed by removing parts of the insulating thin-film layer 28 except for parts in which the insulating protection layer will be formed. The insulating protection layer 30 has a thickness of approximately 50 to 300 nm (preferably, a thickness of approximately 150 nm) at room temperature. The insulating protection layer 30 is used to insulate the magnetoresistance devices 60 and the electrode pads 26a and 26b from the corrosion effect of the analysis solution. The insulating protection layer 30 is configured unlike the existing structure. The insulating protection layer 30 protects the plurality of magnetoresistance devices 60 and the plurality of electrode pads 26a and 26b from the corrosion, thereby improving the reliability of the product. FIG. 42A is a plan view and FIG. 42B is a diagram illustrating a state in which the insulating protection layer 30 is formed and is a cross-sectional view taken along line A-A of FIG. 42A.

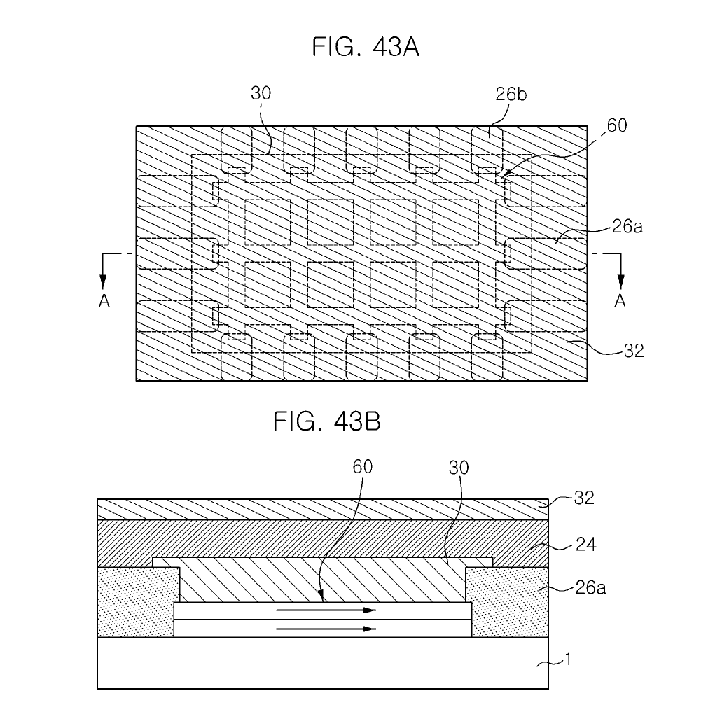

Thereafter, as shown in FIGS. 43A and 43B, the Au metal thin film 32 is deposited on the electrode pads 26a and 26b and the insulating protection layer 30 via the photosensitive thin film 24. The Au metal thin film 32 is used to form the biomolecules fixed layer for fixing the biomolecules to the top of the magnetoresistance device 60. The Au metal thin film 32 grows up in a thickness of approximately 50 to 300 nm (preferably, a thickness of 150 nm) by the sputtering deposition method at room temperature by applying the argon gas pressure of approximately 3×10⁻⁴ Torr and the sputtering power of approximately 100 W. FIG. 43A is a plan view and FIG. 43B is a diagram illustrating a state in which the Au metal thin film 32 is formed and is a cross-sectional view taken along line A-A of FIG. 43A.

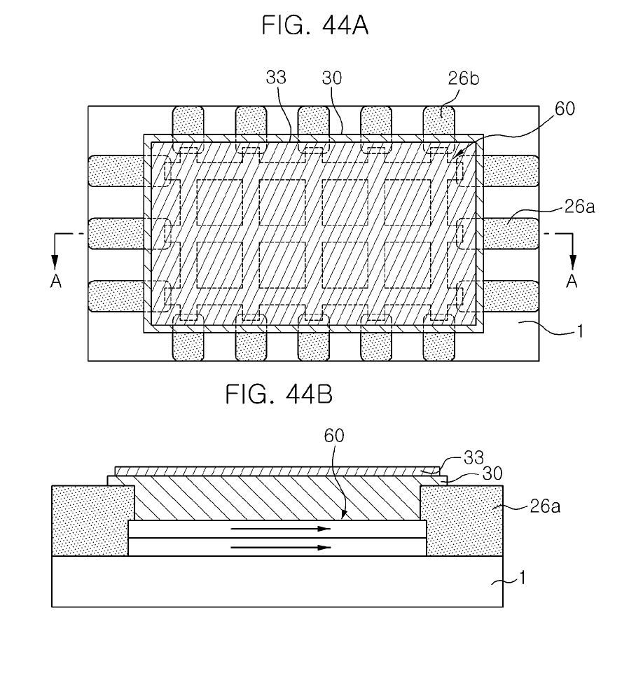

As shown in FIGS. 44A and 44B, the biomolecules fixed layer 33 is formed by selectively removing the Au metal thin film 32. By the dry etching method such as the Ar gas ion milling method or the lift-up method using the negative photosensitive mask, the biomolecules fixed layer 33 is formed by removing parts of the Au metal thin film 32 except for parts in which the biomolecules fixed layer 33 will be formed. That is, the biomolecules fixed layer 33 has a thickness of approximately 50 to 300 nm (preferably, a thickness of approximately 150 nm) at room temperature. The biomolecules fixed layer 33 is configured unlike the existing structure. The biomolecules fixed layer 33 can more easily and accurately fix the biomolecules, thereby improving the reliability of the product. FIG. 44A is a plan view and FIG. 44B is a diagram illustrating a state in which the biomolecules fixed layer 33 is formed and is a cross-sectional view taken along line A-A of FIG. 44A.

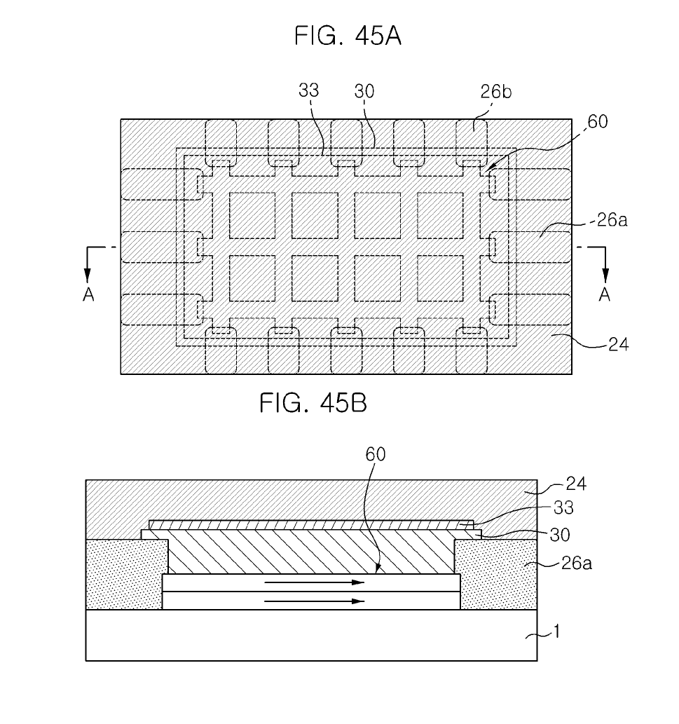

Thereafter, as shown in FIGS. 45A and 45B, the photosensitive thin film 24 is deposited on the electrode pads 26a and 26b, the insulating protection layer 30, and the biomolecules fixed layer 33. FIG. 45A is a plan view and FIG. 45B is a diagram illustrating a state in which the photosensitive thin film 24 is deposited and is a cross-sectional view taken along line A-A of FIG. 45A.

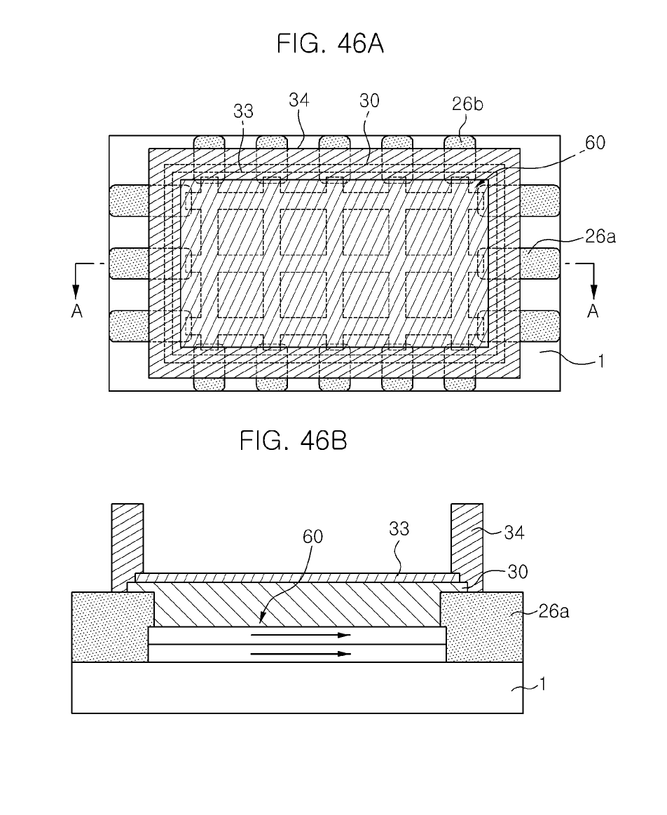

As shown in FIGS. 46A and 46B, the magnetic bead container layer 34 is formed by selectively removing the photosensitive thin film 24 of FIGS. 45A and 45B. The magnetic bead container layer 34 allows the magnetic bead analysis solution (that is, analysis solution containing the magnetic beads) to be positioned adjacent to the magnetoresistance device 60. That is, the magnetic bead container layer 34 positioned on the periphery of the magnetoresistance device 60 coops up the magnetic bead analysis solution. The magnetic bead container layer 34 is formed by the spin coating method so as to have a thickness of approximately 1 to 5 μm. The magnetic bead container layer 34 is made of the photosensitive polymer. The magnetic bead container layer 34 is formed by selectively removing parts of the photosensitive thin film 24 of FIGS. 45A and 45B except for parts in which the magnetic bead container layer 34 will be formed by the lift-up method using the negative photosensitive mask. The magnetic bead container layer 34 is configured unlike the existing structure. The magnetic bead container layer 34 further facilitates sensing in the magnetoresistance device 60, thereby improving the reliability of the product. FIG. 46A is a plan view and FIG. 46B is a diagram illustrating a state in which the magnetic bead container layer 34 is formed and is a cross-sectional view taken along line A-A of FIG. 46A.

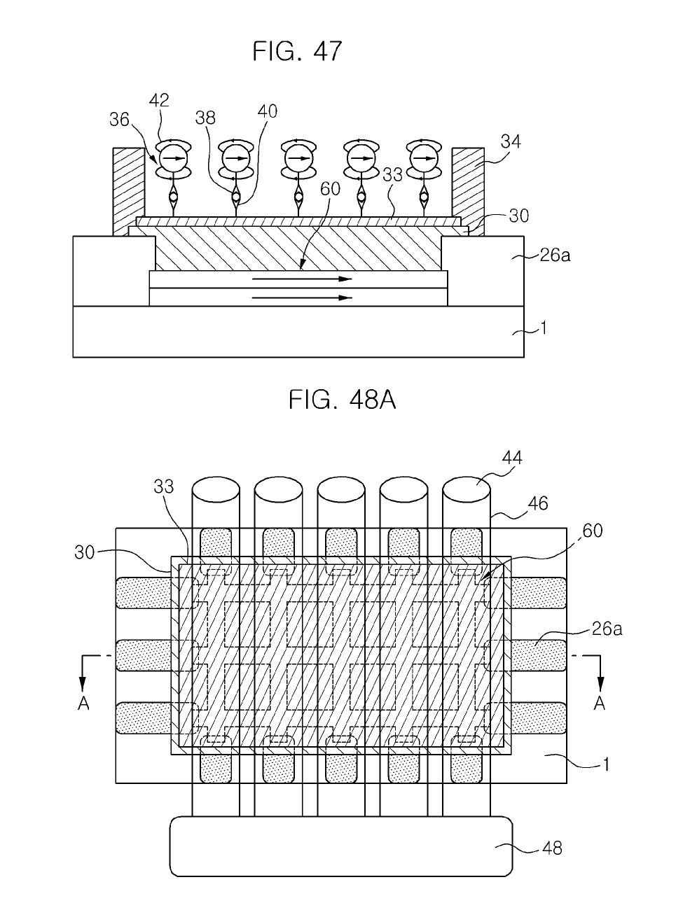

In the case of the cross-type magnetic array sensor for biomolecules magnetic bead detection manufactured by the above-mentioned process, as shown in FIG. 47, when the magnetic bead analysis solution is inputted into the magnetic bead container layer 34, the biomolecules 38 attached to the magnetic beads 36 in the magnetic bead analysis solution and the biomolecules 40 attached to the biomolecules fixed layer 33 are specifically combined with each other and as a result, the combined biomolecules are fixed onto the magnetoresistance device 60 having the structure in which the plurality of cross-type magnetoresistance devices are horizontally and vertically integrated. The magnetic beads 36 are magnetized by the magnetic field applied from the outside and as a result, the magnetoresistance device 60 detects the existence of the magnetic beads 36. Alternatively, the magnetic beads 36 that are magnetized by the applied current induction magnetic field generated by the applied current are magnetized and as a result, the magnetoresistance device 60 detects the existence of the magnetic beads 36.

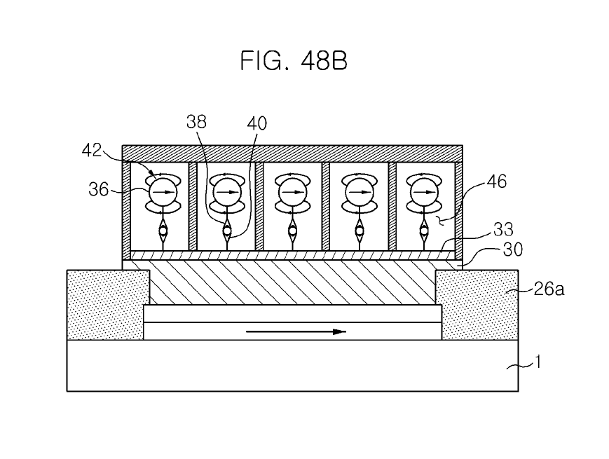

FIGS. 48A and 48B are diagrams illustrating a modified example of a fourth embodiment of the present invention. Although the magnetic bead container layer 34 is formed so as to allow the magnetic bead analysis solution to be positioned adjacent to the magnetoresistance device 50 in the fourth embodiment, the magnetic bead analysis moving layer (to be described later) is used instead of the magnetic bead container layer 34 in a modified example of the fourth embodiment.

The modified example of the fourth embodiment includes the magnetoresistance devices 60 that grow up on the substrate 1 and the electrode pads 26a and 26b. The insulating protection layer 30 is deposited on all the magnetoresistance devices 60 and some of the electrode pads 26a and 26b. The biomolecules fixed layer 33 is formed on the insulating protection layer 30. The magnetic bead solution inlet 44, the moving channel 46, and the outlet 48 are disposed on the biomolecules fixed layer 33 and are disposed to conform to the placement position (that is, the position of each magnetoresistance device when the plurality of integrated magnetoresistance devices are separated one by one for each unit device) of the magnetoresistance device 60. That is, one end of the moving channel 46 is connected to the magnetic bead solution inlet 44 and the other end of the moving channel 46 is connected to the outlet 48. Herein, the magnetic bead solution inlet 44, the moving channel 46, and the outlet 48 can be generally named as the magnetic bead analysis moving layer. The magnetic bead analysis moving layer is made of PDMS, PMMA, and the SU-8 polymer. The magnetic beads 36 in the analysis solution are injected into the magnetic bead solution inlet 44 and move to the magnetoresistance devices 60 through the moving channel 46. The output voltage of the magnetoresistance device 60 is varied by the specific combination of the biomolecules 38 attached to the magnetic beads 36 and the biomolecules 40 fixed to the biomolecules fixed layer 33. Therefore, the existence of the magnetic beads 36 is detected.

The present invention is not limited to the foregoing embodiments, but the embodiments may be configured by selectively combining all the embodiments or some of the embodiments so that various modifications can be made.

What is claimed is:

1. A cross-type magnetic array sensor for biomolecules magnetic bead detection, comprising:
a substrate;
a plurality of cross-type magnetoresistance devices that are formed on the top of the substrate and are formed by using a thin film for detecting biomolecules;
electrode pads that are formed on the top of the substrate and connected to the plurality of cross-type magnetoresistance devices;
a protection layer that is formed on the tops of the plurality of cross-type magnetoresistance device and the electrode pads;
a biomolecules fixed layer that is formed on the top of the protection layer to fix the biomolecules; and
a magnetic bead container layer that surrounds the biomolecules fixed layer and coops up a magnetic bead analysis solution in the surrounded area.

2. The cross-type magnetic array sensor according to claim 1, wherein the magnetic bead container layer is formed by using a photosensitive thin film.

3. The cross-type magnetic array sensor according to claim 1, wherein the magnetic bead container layer has a thickness of 1 to 5 μm at room temperature.

4. The cross-type magnetic array sensor according to claim 1, wherein the substrate is a Si single crystalline substrate of which the surface is oxidized.

5. The cross-type magnetic array sensor according to claim 1, wherein the thin film is any one of a giant magnetoresistance thin film, a spin valve thin film, and an anisotropic magnetoresistance thin film.

6. The cross-type magnetic array sensor according to claim 1, wherein the thin film is configured by sequentially forming a seed layer, an anti-ferromagnetic layer, a fixed layer, a space layer, a free layer, and a protection layer.

7. The cross-type magnetic array sensor according to claim 1, wherein the plurality of cross-type magnetoresistance devices each have a size of 100 nm to 100 μm.

8. The cross-type magnetic array sensor according to claim 1, wherein the plurality of cross-type magnetoresistance devices are formed on the substrate in a one-dimensional array pattern in which the magnetoresistance devices are independently arrayed in line.

9. The cross-type magnetic array sensor according to claim 1, wherein the plurality of cross-type magnetoresistance devices are formed on the substrate in a one-dimensional array pattern in which the magnetoresistance devices are connected to each other to be integrated.

10. The cross-type magnetic array sensor according to claim 1, wherein the plurality of cross-type magnetoresistance devices are formed on the substrate in a two-dimensional array pattern in which the magnetoresistance devices are independently arrayed in a matrix pattern.

11. The cross-type magnetic array sensor according to claim 1, wherein the plurality of cross-type magnetoresistance devices are formed on the substrate in a two-dimensional array pattern in which the magnetoresistance devices are connected to each other to be integrated.

12. The cross-type magnetic array sensor according to claim 1, wherein the electrode pad is made of Ta or Au.

13. The cross-type magnetic array sensor according to claim 1, wherein the electrode pad has a thickness of 50 to 300 nm at room temperature.

14. The cross-type magnetic array sensor according to claim 1, wherein the protection layer is made of SiO₂ or Si₃N₄.

15. The cross-type magnetic array sensor according to claim 1, wherein the protection layer has a thickness of 50 to 300 nm at room temperature.

16. The cross-type magnetic array sensor according to claim 1, wherein the biomolecules fixed layer is made of Au.

17. The cross-type magnetic array sensor according to claim 1, wherein the biomolecules fixed layer has a thickness of 50 to 300 nm at room temperature.

18. A cross-type magnetic array sensor for biomolecules magnetic bead detection, comprising:
a substrate;
a plurality of cross-type magnetoresistance devices that are formed on the top of the substrate and are formed by using a thin film for detecting biomolecules;
electrode pads that are formed on the top of the substrate and connected to the plurality of cross-type magnetoresistance devices;
a protection layer that is formed on the tops of the plurality of cross-type magnetoresistance device and the electrode pads;
a biomolecules fixed layer that is formed on the top of the protection layer to fix the biomolecules; and
a magnetic bead analysis moving layer that is formed on the biomolecules fixed layer and moves a magnetic bead analysis solution to the plurality of cross-type magnetoresistance devices.

19. The cross-type magnetic array sensor according to claim 18, wherein the magnetic bead analysis moving layer is constituted by a moving channel having a predetermined length, of which one end is connected to a magnetic bead solution inlet and the other end is connected to an outlet.

20. The cross-type magnetic array sensor according to claim 18, wherein the magnetic bead analysis moving layer is made of any one material of PDMS, PMMA, and an SU-8 polymer.
